(19) United States
(12) Patent Application Publication
(10) Pub. No.: US 2020/0364784 A1
(43) Pub. Date: Nov. 19, 2020

(54) System, Method, and Apparatus for Providing a Closed End Credit Account Associated with a Debit Account

(71) Applicant: Visa International Service Association, San Francisco, CA (US)

(72) Inventor: Matthew Dill, Singapore (SG)

(21) Appl. No.: 16/638,504

(22) PCT Filed: Aug. 16, 2017
(86) PCT No.: PCT/US2017/047078

§ 371 Date: Feb. 12, 2020

(51) Int. Cl. G06Q 40/02; G06Q 20/40

(52) U.S. Cl. CPC G06Q 40/025; G06Q 20/405; G06Q 20/401

(57) ABSTRACT

Provided is a computer-implemented method for providing a closed end credit account associated with a debit account. The method may include determining a transaction between a consumer and a merchant involving a debit account, determining transaction data of the transaction, determining an allotted credit amount based at least partially on at least one credit allotment rule and at least one of the transaction data, user data of the at least one consumer, merchant identity data, merchant category data, transaction identifier data, timing data, issuer institution data, or any combination thereof, generating at least one repayment plan for the closed end credit account, activating the closed end credit account having the allotted credit amount, and causing the closed end credit account to be applied to the debit account in response to activating the closed end credit account. A system and computer program product are also disclosed.

### BACKGROUND OF THE INVENTION

### 1. Field of the Invention

This invention relates generally to systems that provide closed end credit accounts and, in one particular embodiment, to a system, method, and apparatus for providing a closed end credit account, aspects of which may be determined based on a transaction, where the transaction may involve a debit account.

### 2. Technical Considerations

A debit card (e.g., a bank card, a check card, and/or the like) may be a payment card associated with a debit account that a user employs to use electronic funds (e.g., electronic money) instead of physical funds (e.g., physical money, cash, and/or the like) when conducting a transaction. When using a debit card in a transaction, for example, when a user makes a purchase, the funds for the transaction may come directly from the debit account (e.g., a bank account, a checking account, and/or the like) of the user. Transactions involving a debit account are immediately transferred from the user's debit account as opposed to the user paying the funds back at a later date, for example, as with a transaction involving a credit card.

A closed end credit account may be a type of credit account (e.g., a loan, a line of credit, and/or the like) that is characterized as having a repayment amount that must be repaid by a borrower to a lender at the end of a term of the closed end credit account. For example, the borrower, such as a user, may be required to repay a closed end credit account by a specified date, in a specified amount of time, to the lender, such as a bank or a credit card issuer. The repayment amount of a closed end credit account may include, in addition to the principal amount, an interest charge and/or a financial charge that was agreed to by the borrower and the lender. As examples, a closed end credit account in some contexts may include a mortgage, a personal loan, a car loan, or the like.

Despite that electronic funds may be used during a transaction involving a debit account associated with a user, by involving the debit account, the user may be subject to a limit on the amount of funds that may be involved in the transaction for a specific time period (e.g., a day, a week, and/or the like). Additionally, the user may be subject to a maximum limit on the amount of funds that be used during the transaction involving the debit account. The maximum limit may be equal to an account balance of the debit account. Furthermore, a user may desire to keep a specific account balance in the debit account. The user may therefore avoid a transaction, which involves the debit account (e.g., via a debit card), that requires an amount of funds that would reduce the account balance of the debit account below the specific account balance that is desired by the user.

A user may obtain a closed end credit account to provide the user with access to an amount of funds that is greater than the specific time period limit and/or the maximum limit mentioned above. However, a closed end credit account may not be available to the user based on a lender's lack of knowledge of relevant information associated with the user. For example, the lender may lack access to information associated with credit details of the user and/or information associated with an account of the user.

In some instances, the user may not obtain a closed end credit account based on the inability of the user to easily repay the closed end credit account. This may be based on a lack of a communication connection between a lender's systems and a user device (e.g., an electronic device, a mobile device, and/or the like) associated with the user. In addition, technical difficulties in obtaining the closed end credit account may prevent the user from obtaining the closed end credit account. For example, the lender may fail to provide an account application process that is simple to understand and prevents the user from easily and accurately providing information as part of an application for the closed end credit account.

Additionally, in some instances, the user may forego obtaining a closed end credit account based on a lack of knowledge, on the part of the user, that a closed end credit account may be available to the user. Further, in some instances, the user may forego obtaining a closed end credit account based on the amount of time that may be associated with the user waiting to receive information (e.g., repayment plan parameters of a repayment plan, and/or the like) associated with the closed end credit account, the amount of time that may be associated with the user waiting to be approved for the closed end credit account, and/or the amount of time associated with the user waiting for an amount of funds associated with the closed end credit account to be provided to the user after the user is approved for the closed end credit account.

### SUMMARY OF THE INVENTION

Accordingly, provided is an improved apparatus, device, system, and/or method for providing a closed end credit account associated with a debit account.

According to a non-limiting embodiment, provided is a computer-implemented method for providing a closed end credit account associated with a debit account of at least one consumer. The method comprises determining, with at least one processor, at least one transaction between the at least one consumer and at least one merchant involving the debit account; determining, with at least one processor, transaction data of the at least one transaction; determining, with at least one processor, an allotted credit amount of the closed end credit account based at least partially on at least one credit allotment rule and at least one of the following: transaction data of the at least one transaction, user data of the at least one consumer, merchant identity data of the at least one merchant, merchant category data of the at least one merchant, issuer institution data of an issuer institution, or any combination thereof; generating, with at least one processor, at least one repayment plan for the closed end credit account; activating, with at least one processor, the closed end credit account having the allotted credit amount; and processing, with at least one processor, the at least one transaction using the closed end credit account in response to activating the closed end credit account.

According to another non-limiting embodiment, provided is a system for providing a closed end credit account associated with a debit account of at least one consumer, the system comprising: at least one processor programmed or configured to: determine transaction data of at least one transaction between the at least one consumer and at least one merchant; determine an allotted credit amount of the closed end credit account based at least partially on at least one of the following: the transaction data, user data of the at least one consumer, merchant identity data of the at least one merchant, merchant category data of the at least one merchant, issuer institution data of an issuer institution, or any combination thereof; activate the closed end credit account having the allotted credit amount; generate at least one repayment plan for the closed end credit account; and process the at least one transaction between the at least one consumer and the at least one merchant using the closed end credit account in response to activating the closed end credit account.

According to a further non-limiting embodiment, provided is A non-transitory computer-readable medium storing instructions for providing a closed end credit account associated with a debit account, the instructions comprising: one or more instructions that, when executed by at least one processor, cause the at least one processor to: receive transaction data of at least one transaction between a user and a merchant, wherein the at least one transaction involves a debit account of the at least one consumer; determine an allotted credit amount of the closed end credit account based at least partially on at least one credit allotment rule, the transaction data, and at least one of the following: user data of the user, merchant data of the merchant, issuer institution data of an issuer institution that issued the debit account, or any combination thereof; generate at least one repayment plan for the closed end credit account; communicate the at least one repayment plan to a user device associated with the user; receive acceptance data that indicates acceptance of the at least one repayment plan; activate the closed end credit account; and process the at least one transaction in response to activating the closed end credit account.

Further embodiments or aspects are set forth in the following numbered clauses:

Clause 1: A computer-implemented method for providing a closed end credit account associated with a debit account of at least one consumer, the method comprising: determining, with at least one processor, at least one transaction between the at least one consumer and at least one merchant involving the debit account; determining, with at least one processor, transaction data of the at least one transaction; determining, with at least one processor, an allotted credit amount of the closed end credit account based at least partially on at least one credit allotment rule and at least one of the following: the transaction data of the at least one transaction, user data of the at least one consumer, merchant identity data of the at least one merchant, merchant category data of the at least one merchant, issuer institution data of an issuer institution, or any combination thereof; generating, with at least one processor, at least one repayment plan for the closed end credit account; activating, with at least one processor, the closed end credit account having the allotted credit amount; and processing, with at least one processor, the at least one transaction using the closed end credit account in response to activating the closed end credit account.

Clause 2: The computer-implemented method of clause 1, wherein the closed end credit account is activated in response to determining the allotted credit amount.

Clause 3: The computer-implemented method of clauses 1 or 2, wherein generating the at least one repayment plan comprises automatically generating the at least one repayment plan based at least partially on at least one repayment plan rule and at least one of the following: the allotted credit amount, the user data, the merchant identity data, the merchant category data, transaction identifier data, a transaction amount, timing data, the issuer institution data, or any combination thereof.

Clause 4: The computer-implemented method of any of clauses 1-3, further comprising: transferring or causing funds to be transferred from the debit account of the at least one consumer to the closed end credit account based at least partially on the at least one repayment plan.

Clause 5: The computer-implemented method of any of clauses 1-4, further comprising: receiving at least one user-selected parameter comprising at least one of the following: the allotted credit amount, the merchant identity data, the merchant category data, transaction amount data, timing data, the user data, the issuer institution data, the at least one repayment plan, or any combination thereof.

Clause 6: The computer-implemented method of any of clauses 1-5, further comprising: generating at least one message; and communicating the at least one message to the at least one consumer.

Clause 7: The computer-implemented method of any of clauses 1-6, wherein the at least one message comprises at least one of the following: an offer to activate the closed end credit account, transaction data of at least one past transaction that is eligible to be associated with an existing closed end credit account, transaction data of at least one past transaction that is eligible to be associated with a new closed end credit account, a plurality of repayment plans each associated with different repayment plan parameters, an offer to activate an open end credit account, or any combination thereof.

Clause 8: The computer-implemented method of any of clauses 1-7, wherein communicating the at least one message to the at least one consumer comprises communicating the at least one message to a mobile device associated with the at least one consumer.

Clause 9: A system for providing a closed end credit account associated with a debit account of at least one consumer, the system comprising: at least one processor programmed or configured to: determine transaction data of at least one transaction between the at least one consumer and at least one merchant; determine an allotted credit amount of the closed end credit account based at least partially on at least one of the following: the transaction data, user data of the at least one consumer, merchant identity data of the at least one merchant, merchant category data of the at least one merchant, issuer institution data of an issuer institution, or any combination thereof; activate the closed end credit account having the allotted credit amount; generate at least one repayment plan for the closed end credit account; and process the at least one transaction between the at least one consumer and the at least one merchant using the closed end credit account in response to activating the closed end credit account.

Clause 10: The system of clause 9, wherein the at least one processor, when determining the allotted credit amount, is further programmed or configured to determine the allotted credit amount before determining the transaction data of the at least one transaction.

Clause 11: The system of clauses 9 or 10, wherein the at least one processor, when generating at least one repayment plan, is further programmed or configured to generate the at least one repayment plan based at least partially on at least one of the following: merchant identity data of the at least one merchant, merchant category data of the at least one merchant, transaction data of the at least one transaction, a transaction amount, timing data, the user data, issuer institution data, or any combination thereof.

Clause 12: The system of any of clauses 9-11, wherein the at least one processor is further programmed or configured to cause a user interface to be displayed by a mobile device of the at least one consumer.

Clause 13: The system of any of clauses 9-12, wherein the user interface comprises at least one of the following: debit account data of the debit account; closed end credit account data of the closed end credit account; the allotted credit amount, the merchant identity data, the merchant category data, a transaction amount, timing data, the user data, the issuer institution data, the at least one repayment plan, at least one message, or any combination thereof.

Clause 14: The system of any of clauses 9-13, wherein the user interface comprises a user selectable element associated with at least one of the following: an offer to activate the closed end credit account, transaction data of at least one past transaction that is eligible to be associated with an existing closed end credit account, transaction data of at least one past transaction that is eligible to be associated with a new closed end credit account, a plurality of repayment plans each having different repayment plan parameters, an offer to activate an open end credit account, or any combination thereof.

Clause 15: A non-transitory computer-readable medium storing instructions for providing a closed end credit account associated with a debit account, the instructions comprising: one or more instructions that, when executed by at least one processor, cause the at least one processor to: receive transaction data of at least one transaction between a user and a merchant that involves a debit account of the user; determine that the transaction data corresponds with predetermined transaction criteria; determine an allotted credit amount of the closed end credit account based at least partially on at least one credit allotment rule, the transaction data, and at least one of the following: user data of the user, merchant data of the merchant, issuer institution data of an issuer institution that issued the debit account, or any combination thereof; generate at least one repayment plan for the closed end credit account; communicate the at least one repayment plan to a user device associated with the user; receive acceptance data that indicates acceptance of the at least one repayment plan; activate the closed end credit account; and process the at least one transaction in response to activating the closed end credit account.

Clause 16: The non-transitory computer-readable medium of clause 15, wherein the transaction data of the at least one transaction comprises a transaction amount of the at least one transaction.

Clause 17: The non-transitory computer-readable medium of clauses 15 or 16, wherein the one or more instructions, when executed by the at least one processor, further cause the at least one processor to: determine that the transaction data of at least one transaction corresponds with predetermined transaction criteria.

Clause 18: The non-transitory computer-readable medium of any of clauses 15-17, wherein the one or more instructions, when executed by the at least one processor, further cause the at least one processor to: receive the predetermined transaction criteria from the user.

Clause 19: The non-transitory computer-readable medium of any of clauses 15-18, wherein the user data is first user data, the merchant data is first merchant data, and the issuer institution data is first issuer institution data, and wherein the one or more instructions, that cause the at least one processor to generate the at least one repayment plan, further cause the at least one processor to: generate the at least one repayment plan based at least partially on at least one of the following: second user data of the user, second merchant data of the merchant, second issuer institution data of the issuer institution that issued the debit account, or any combination thereof.

Clause 20: The non-transitory computer-readable medium of any of clauses 15-19, wherein the one or more instructions, when executed by the at least one processor, further cause the at least one processor to: communicate an offer message to the user device in response to receiving the transaction data of at least one transaction, wherein the offer message comprises on offer to activate the closed end credit account.

Clause 21: A system comprising at least one processor to: receive transaction data of at least one transaction between at least one user and at least one merchant involving a debit account of the at least one user; determine whether to activate a closed end credit account after receiving the transaction data of the at least one transaction, wherein determining whether to activate the closed end credit account is based at least partially on at least one credit account provision rule, the transaction data of the at least one transaction, and at least one of the following: first user data of the at least one user, first merchant data of the at least one merchant, first issuer institution data of an issuer institution that issued the debit account, or any combination thereof; determine an allotted credit amount for the closed end credit account, where the allotted credit amount is determined based on a transaction amount of the at least one transaction; generate at least one repayment plan for the closed end credit account in response to determining the allotted credit amount for the closed end credit account, wherein the at least one repayment plan is generated based at least partially on at least one repayment rule and at least one of the following: the transaction data of the at least one transaction, second user data of the at least one user, second merchant data of the at least one merchant, second issuer institution data of the issuer institution that issued the debit account, or any combination thereof; communicate repayment plan parameters of the at least one repayment plan for the closed end credit account to a user device associated with the at least one user; receive acceptance data that indicates acceptance of the at least one repayment plan from the user device; activate the closed end credit account having the allotted credit amount; and process the at least one transaction in response to activating the closed end credit account.

Clause 22: The system of clause 21, wherein the at least one processor, when activating the closed end credit account, is to: activate the closed end credit account based on receiving the acceptance data, from the user device, that indicates acceptance of the at least one repayment plan.

Clause 23: The system of clauses 21 or 22, wherein the at least one processor is further to: receive the predetermined transaction criteria before receiving the transaction data; determine that the transaction data corresponds with the predetermined transaction criteria; and wherein the at least one processor, when determining whether to activate the closed end credit account associated with the debit account of the at least one user, is to: determine whether to activate the closed end credit account associated with the debit account of the at least one user in response to determining that the transaction data of the at least one transaction corresponds with the predetermined transaction criteria.

Clause 24: The system of any of clauses 21-23, wherein the predetermined transaction criteria comprises at least one of the following: predetermined merchant identity data, predetermined merchant category data, predetermined transaction amount data, predetermined timing data, predetermined issuer institution identity data, or any combination thereof.

Clause 25: The system of any of clauses 21-24, wherein the at least one processor is further to: cause a transfer of funds from the debit account of the at least one user to be applied to the closed end credit account.

Clause 26: The system of any of clauses 21-25, wherein the user device is a mobile device associated with the at least one user, and wherein the at least one processor is further to: generate an offer message in response to determining to activate the closed end credit account, wherein the offer message comprises an offer to activate the closed end credit account; communicate the offer message to the user device; and receive, from the user device, acceptance data that indicates acceptance of the offer to activate the closed end credit account after communicating the offer message.

Clause 27: The system of any of clauses 21-26, wherein the transaction data is first transaction data, the at least one transaction is a first transaction, and the at least one processor is further to: receive second transaction data of a second transaction between the at least one user and the at least one merchant involving the debit account of the at least one user; and communicate an offer message, to the at least one user, to associate the second transaction with the closed end credit account after receiving the second transaction data of the second transaction.

Clause 28: The system of any of clauses 21-27, wherein the at least one processor is further to cause a user interface to be displayed on the user device, wherein the user interface comprises at least one of the following: debit account data of the debit account, closed end credit account data of the closed end credit account, a transaction amount of the transaction amount of the at least one transaction, timing data of the at least one transaction, repayment plan parameters of the at least one repayment plan, or any combination thereof.

Clause 29: The system of any of clauses 21-28, wherein the transaction data is first transaction data, the at least one transaction is at least one first transaction, and wherein the user interface comprises at least one user selectable element associated with at least one of the following: initiation data to initiate activation of the closed end credit account, second transaction data of at least one second transaction that is eligible to be associated with the closed end credit account, repayment plan parameters of the at least one repayment plan, or any combination thereof.

Clause 30: A computer-implemented method comprising receiving, with at least one processor, first transaction data of a plurality of transactions between at least one user and at least one merchant, where each of the plurality of transactions involves a debit account of the at least one user; determining, with at least one processor, at least one transaction of the plurality of transactions that corresponds with predetermined transaction criteria based on second transaction data of the at least one transaction; determining, with at least one processor, to activate a closed end credit account in response to determining that the at least one transaction corresponds with the predetermined transaction criteria, wherein determining to activate the closed end credit account is based at least partially on at least one credit account provision rule, the second transaction data, and at least one of the following: user data of the at least one user, merchant data of the at least one merchant, issuer institution data of an issuer institution that issued the debit account, or any combination thereof; determining, with at least one processor, an allotted credit amount for the closed end credit account based at least partially on the second transaction data and the user data of the at least one user; generating, with at least one processor, at least one repayment plan; communicating, with at least one processor and to a user device associated with the at least one user, repayment plan parameters of the at least one repayment plan in response to generating the at least one repayment plan; receiving, with at least one processor, acceptance data that indicates acceptance of the at least one repayment plan; activating the closed end credit account having the allotted credit amount; and processing the at least one transaction in response to activating the closed end credit account.

Clause 31: The computer-implemented method of clause 30, wherein activating the closed end credit account comprises: activating the closed end credit account in response to receiving the acceptance data that indicates acceptance of the at least one repayment plan.

Clause 32: The computer-implemented method of clauses 30 or 31, wherein the user data is first user data, the merchant data is first merchant data, and the issuer institution data is first issuer institution data, and wherein generating the at least one repayment plan comprises: generating the at least one repayment plan based at least partially on at least one repayment rule and at least one of the following: second transaction data of the at least one transaction, second user data of the at least one user, second merchant data of at least one merchant involved in the at least one transaction, second issuer institution data of the issuer institution that issued the debit account, or any combination thereof.

Clause 33: The computer-implemented method of any of clauses 30-32, further comprising causing a user interface to be displayed on the user device, wherein the user interface comprises at least one of the following: a transaction amount of the at least one transaction, timing data of the at least one transaction, repayment plan parameters of the at least one repayment plan, or any combination thereof.

Clause 34: The computer-implemented method of any of clauses 30-33, further comprising causing a user interface to be displayed on the user device in response to determining that the at least one transaction of the plurality of transactions corresponds with the predetermined transaction criteria, wherein the user interface comprises the second transaction data.

Clause 35: A non-transitory computer-readable medium storing instructions, wherein the instructions comprise one or more instructions that, when executed by at least one processor, cause the at least one processor to: receive transaction data of at least one transaction between at least one user and at least one merchant involving a debit account of the at least one user; determine an allotted credit amount of a closed end credit account based at least partially on at least one credit allotment rule, transaction data of the at least one transaction, and at least one of the following: merchant data of the at least one merchant, user data of the at least one user, issuer institution data of an issuer institution that issued the debit account, or any combination thereof; generate at least one repayment plan wherein the at least one repayment plan is based on the allotted credit amount; communicate repayment plan parameters of the at least one repayment plan to a mobile device associated with the at least one user; receive acceptance data indicating acceptance of the at least one repayment plan from the mobile device; activate the closed end credit account based on receiving the acceptance data from the mobile device; and process the at least one transaction in response to activating the closed end credit account.

Clause 36: The non-transitory computer-readable medium of clause 35, wherein the transaction data of the at least one transaction comprises at least one of the following: user transaction data of the at least one user; merchant transaction data of the at least one merchant; a transaction amount of the at least one transaction; timing data of the at least one transaction; issuer institution data of the issuer institution that issued the debit account; or any combination thereof.

Clause 37: The non-transitory computer-readable medium of clauses 35 or 36, wherein the one or more instructions further cause the at least one processor to: determine that the transaction data of at least one transaction corresponds with predetermined transaction criteria; and wherein the one or more instructions, that cause the at least one processor to determine the allotted credit amount of the closed end credit account, cause the at least one processor to: determine the allotted credit amount of the closed end credit account after determining that the transaction data of at least one transaction corresponds with the predetermined transaction criteria.

Clause 38: The non-transitory computer-readable medium of any of clauses 35-37, wherein the one or more instructions further cause the at least one processor to: communicate a notification message to the mobile device associated with the at least one user in response to determining that the transaction data of the at least one transaction corresponds with predetermined transaction criteria; wherein the notification message comprises a transaction amount of the at least one transaction.

Clause 39: The non-transitory computer-readable medium of any of clauses 35-38, wherein the user data is first user data, the merchant data is first merchant data, and the issuer institution data is first issuer institution data, and wherein the one or more instructions further cause the at least one processor to: determine to activate the closed end credit account in response to receiving the transaction data of the at least one transaction; and determining to activate the closed end credit account is based at least partially on at least one credit account provision rule, and at least one of the following: second user data of the at least one user, second merchant data of the at least one merchant, second issuer institution data of the issuer institution that issued the debit account, or any combination thereof.

Clause 40: The non-transitory computer-readable medium of any of clauses 35-39, wherein the user data is first user data, the merchant data is first merchant data, and the issuer institution data is first issuer institution data, and the one or more instructions, that cause the at least one processor to generate the repayment plan, further cause the at least one processor to: generate the repayment plan based at least partially on at least one repayment rule and at least one of the following: the transaction data of the at least one transaction; second user data of the at least one user; second merchant data of the at least one merchant; second issuer institution data of the issuer institution that issued the debit account; or any combination thereof.

Clause 41: A system comprising at least one processor to: receive initiation data to initiate activation of a closed end credit account; receive a user selected allotted credit amount of the closed end credit account; generate at least one repayment plan based at least partially on at least one repayment rule and user data of the user; communicate repayment plan parameters of the at least one repayment plan in response to generating the at least one repayment plan; receive acceptance data that indicates acceptance of the at least one repayment plan; activate the closed end credit account; and process the at least one transaction in response to activating the closed end credit account.

Clause 42: The system of clause 41, wherein the at least one processor is further to: determine to activate the closed end credit account before receiving the initiation data.

Clause 43: The system of clauses 41 or 42, wherein the at least one processor, when determining to activate the closed end credit account, is further to: determine to activate the closed end credit account based at least partially on at least one credit account provision rule and user data of the user.

Clause 44: The system of any of clauses 41-43, wherein the at least one processor, when activating the closed end credit account, is further to: activate the closed end credit account in response to receiving the acceptance data that indicates acceptance of the at least one repayment plan.

Clause 45: The system of any of clauses 41-44, wherein the at least one processor is further to: determine a maximum allotted credit amount of the closed end credit account based on user data of the user; and communicate the maximum allotted credit amount to a user device associated with the user.

Clause 46: The system of any of clauses 41-45, wherein the user selected allotted credit amount of the closed end credit account is equal to or less than the maximum allotted credit amount.

Clause 47: A computer-implemented method comprising: receiving, with at least one processor, initiation data to initiate activation of a closed end credit account; receiving, with at least one processor, a user selected allotted credit amount of the closed end credit account; generating, with at least one processor, at least one repayment plan based at least partially on at least one repayment rule and user data of the user; communicating, with at least one processor, repayment plan parameters of the at least one repayment plan in response to generating the at least one repayment plan; receiving, with at least one processor, acceptance data that indicates acceptance of the at least one repayment plan; and activating, with at least one processor, the closed end credit account.

Clause 48: The computer-implemented method of clause 47, further comprising: processing the at least one transaction using the closed end credit account in response to activating the closed end credit account.

Clause 49: The computer-implemented method of clauses 47 or 48, further comprising: determining to activate the closed end credit account before receiving the initiation data.

Clause 50: The computer-implemented method of any of clauses 47-49, wherein determining to activate the closed end credit account comprises: determining to activate the closed end credit account based at least partially on at least one credit account provision rule and user data of the user.

Clause 51: The computer-implemented method of any of clauses 47-50, wherein activating the closed end credit account comprises: activating the closed end credit account in response to receiving the acceptance data that indicates acceptance of the at least one repayment plan.

Clause 52: The computer-implemented method of any of clauses 47-51, further comprising: determining a maximum allotted credit amount of the closed end credit account based on user data of the user; and communicating the maximum allotted credit amount to a user device associated with the user.

Clause 53: The computer-implemented method of any of clauses 47-52, wherein the user selected allotted credit amount of the closed end credit account is equal to or less than the maximum allotted credit amount.

Clause 54: The computer-implemented method of any of clauses 47-53, further comprising: causing a user interface to be displayed on a user device associated with the user in response to receiving the initiation data; and wherein the user interface comprises a user selectable element that allows the user to provide the user selected allotted credit amount.

Clause 55: A non-transitory computer-readable medium storing instructions, the instructions comprising: one or more instructions that, when executed by at least one processor, cause the at least one processor to: receive initiation data to initiate activation of a closed end credit account; receive a user selected allotted credit amount of the closed end credit account; generate at least one repayment plan based at least partially on at least one repayment rule and user data of the user; communicate repayment plan parameters of the at least one repayment plan in response to generating the at least one repayment plan; receive acceptance data that indicates acceptance of the at least one repayment plan; activate the closed end credit account; and process at least one transaction in response to activating the closed end credit account.

Clause 56: The non-transitory computer-readable medium of clause 55, wherein the one or more instructions further cause the at least one processor to: determine to activate the closed end credit account before receiving the initiation data.

Clause 57: The non-transitory computer-readable medium of clause 55 or 56, wherein the one or more instructions, when causing the at least one processor to determine to provide the closed end credit account, further cause the at least one processor to: determine to activate the closed end credit account based at least partially on at least one credit account provision rule and user data of the user.

Clause 58: The non-transitory computer-readable medium of any of clauses 55-57, wherein the one or more instructions, when causing the at least one processor to activate the closed end credit account, further cause the at least one processor to: activate the closed end credit account in response to receiving the acceptance data that indicates acceptance of the at least one repayment plan.

Clause 59: The non-transitory computer-readable medium of clauses 55-58, wherein the one or more instructions, when executed by the at least one processor, further cause the at least one processor to: determine a maximum allotted credit amount of the closed end credit account based on user data of the user; and communicate the maximum allotted credit amount to a user device associated with the user.

Clause 60: The non-transitory computer-readable medium of clauses 55-59, wherein the user selected allotted credit amount of the closed end credit account is equal to or less than the maximum allotted credit amount.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a diagram of a non-limiting embodiment of an environment in which devices, systems, and/or methods, described herein, may be implemented according to the principles of the present invention;

FIG. 2 is a diagram of a non-limiting embodiment of components of one or more devices of FIG. 1;

FIG. 3 is a flowchart of a non-limiting embodiment of a process for providing a closed end credit account associated with a debit account according to the principles of the present invention;

FIG. 4 is a flowchart of a non-limiting embodiment of a process for providing a closed end credit account associated with a debit account according to the principles of the present invention;

FIGS. 5A-5D are non-limiting embodiments of user interface screens of a user interface displayed by a user device as part of a process for providing a closed end credit account associated with a debit account according to the principles of the present invention;

FIGS. 6A-6H are non-limiting embodiments of user interface screens of a user interface displayed by a user device as part of a process for providing a closed end credit account associated with a debit account according to the principles of the present invention;

FIGS. 7A-7D are non-limiting embodiments of user interface screens of a user interface displayed by a user device as part of providing payments and receiving rewards associated with a closed end credit account associated with a debit account according to the principles of the present invention;

FIG. 8 is a sequence diagram of a non-limiting embodiment of a process for providing a closed end credit account associated with a debit account according to the principles of the present invention; and

FIG. 9 is a sequence diagram of a non-limiting embodiment of another process for providing a closed end credit account associated with a debit account according to the principles of the present invention.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects of the embodiments disclosed herein are not to be considered as limiting unless otherwise indicated.

As used herein, the terms “communication” and “communicate” may refer to the reception, receipt, transmission, transfer, provision, and/or the like, of one or more information, data, signals, messages, instructions, commands, and/or the like. For one unit (e.g., a device, a system, a component of a device or system, combinations thereof, and/or the like) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if at least one intermediary unit (e.g., a third unit located between the first unit and the second unit) processes data received from the first unit and communicates the processed data to the second unit. It will be appreciated that numerous other arrangements are possible.

As used herein, the term “issuer institution” may refer to one or more financial institutions (e.g., a bank, a commercial bank, a credit union, and/or the like), that provide accounts (e.g., a user account, a customer account, a credit account, a credit card account, a debit account, a debit card account, and/or the like) to users (e.g., customers, consumers, and/or the like) for conducting transactions (e.g., a sales transaction, a payment transaction, and/or the like) that initiate a credit payment and/or a debit payment. An issuer institution may be associated with a unique identifier (e.g., a bank identification number (BIN), an issue identification number (IIN), and/or the like) that uniquely identifies the issuer institution among other issuer institutions. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “account identifier” may include one or more types of identifiers associated with a user account (e.g., a personal account number (PAN), a primary account number, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a physical financial instrument (e.g., a portable financial instrument, a payment card, a credit card, a debit card, and/or the like) and/or may be electronic information communicated to the user that the user may use for electronic payments. In some non-limiting embodiments, the account identifier may be an original account identifier, where the original account identifier was provided to a user at the creation of the account associated with the account identifier and a subsequent account identifier (e.g., a supplement account identifier) is provided to the user. An account identifier may be directly or indirectly associated with an issuer institution, such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. Tokens may be associated with a PAN or other account identifiers in one or more databases such that they can be used to conduct a transaction without directly using the account identifier, such as a PAN. In some examples, an account identifier, such as a PAN, may be associated with a plurality of tokens for different users or purposes.

As used herein, the term “merchant” or “merchant system” may refer to one or more entities (e.g., operators of retail businesses) that provides goods and/or services, and/or access to goods and/or services, to users based on a transaction, such as a payment transaction. Merchant or merchant system may also refer to one or more computer systems operated by or on behalf of a merchant, such as a server computer executing one or more software applications. As used herein, the term “product” may refer to one or more goods and/or services offered by a merchant.

As used herein, a “point-of-sale (POS) system” may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that may be used to initiate a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, and in some cases through an agreement between the transaction service provider and the issuing institution. In some non-limiting embodiments, a transaction service provider may include a credit card company, a debit card company, and/or the like. A transaction service provider may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “acquirer” may refer to an entity licensed by the transaction service provider and approved by the transaction service provider to originate transactions using a portable financial device of the transaction service provider. The transactions may include purchases, original credit transactions (OCTs), account funding transactions (AFTs), and other like payment transactions. The acquirer may be authorized by the transaction service provider to sign merchant or service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor. An acquirer may be a financial institution, such as a bank.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet application, a personal digital assistant, a pager, a security card, a computer, an access card, a wireless terminal, and/or a transponder, as examples. The portable financial device may include a volatile or a non-volatile memory to store information (e.g., an account identifier, a name of the account holder, and/or the like).

As used herein, the term “payment facilitator” may refer to a payment processing system operated by or on behalf of an entity that contracts with an acquirer to provide transaction service provider payment services using portable financial devices of the transaction service provider to merchants sponsored by the payment facilitator. A payment facilitator may also refer to the entity that operates such a payment processing system. The payment facilitator may monitor all of its sponsored merchant activity in accordance with regulations of the transaction service provider.

As used herein, the terms “client” and “client device” may refer to one or more client-side devices or systems, remote from a transaction service provider, used to initiate or facilitate a transaction. As an example, a “client device” may refer to one or more POS systems used by a merchant or an acquirer host computer used by an acquirer. It will be appreciated that a client device may be any electronic device configured to communicate with one or more networks and initiate or facilitate transactions such as, but not limited to, one or more computers, portable computers, tablet computers, cellular phones, wearable devices (e.g., watches, glasses, lenses, clothing, and/or the like), personal digital assistants (PDAs), and/or other like devices. Moreover, a “client” may also refer to an entity, such as a merchant or acquirer, that owns, utilizes, and/or operates a client device for initiating transactions with a transaction service provider.

As used herein, the term “server” may refer to or include one or more computing devices, such as processors, storage devices, and/or similar computer components that communicate with client devices and/or other computing devices over a network environment, such as the internet or private networks, and, in some examples, facilitate communication among other servers and/or client devices. It will be appreciated that various other arrangements are possible. As used herein, the term “system” refers to one or more computing devices or combinations of computing devices, such as but not limited to processors, servers, client devices, software applications, and/or other like components.

Non-limiting embodiments of the present invention are directed to a system, method, and computer program product for providing a closed end credit account associated with a debit account. Non-limiting embodiments of the invention may allow a user to obtain a closed end credit account associated with a debit account of the user so that the user may avoid exceeding a limit on the amount of funds that may be involved in a transaction with the debit account for a specific time period (e.g., a day, a week, and/or the like) and/or avoid exceeding a maximum limit on the amount of funds that may be involved in the transaction that includes the debit account. Furthermore, the user may be able to keep a specific account balance in the debit account associated with the user.

Furthermore, non-limiting embodiments of the invention may allow a lender of a closed end credit account to obtain relevant information associated with the user and to provide a closed end credit account to the user based on the relevant information. Additionally, non-limiting embodiments of the invention may provide an interconnection between the lender's systems and a device associated with the user and may alleviate technical issues encountered in obtaining the closed end credit account that may prevent the user from obtaining the closed end credit account. Additionally, non-limiting embodiments of the invention may allow for information to be communicated by the lender to the user that inform the user of a closed end credit account that may be activated for the user.

Furthermore, non-limiting embodiments of the invention may include determining at least one transaction between the at least one consumer and at least one merchant involving the debit account and determining transaction data associated with the at least one transaction. In this way, processor and network resources may be reduced when compared to a user manually searching for a transaction, retrieving transaction data of the transaction, and providing the transaction data of the transaction. In addition, non-limiting embodiments of the invention may also include determining an allotted credit amount of a closed end credit account based at least partially on at least one credit allotment rule and at least one of user data of the at least one consumer, merchant identity data of the at least one merchant, merchant category data of at least one merchant category of the at least one merchant, transaction identifier data of the at least one transaction, timing data of the at least one transaction, issuer institution data of an issuer institution, or any combination thereof. In this way, processor and network resources may be reduced when compared to a user manually submitting a request for an allotted credit amount of a closed end credit account. Processor and network resources may also be reduced when compared to a lender determining whether to provide a closed end credit account having an allotted credit amount that was specified by a user. The amount of time associated with determining an allotted credit amount of a closed end credit account may also be reduced.

In addition, non-limiting embodiments of the invention may also include generating at least one repayment plan for the closed end credit account, activating the closed end credit account having the allotted credit amount, and processing the at least one transaction using the closed end credit account in response to activating the closed end credit account. In this way, processor and network resources may be reduced as compared to a user manually providing information related to a repayment plan as well as information that may be necessary to activate a closed end credit account. Further, the amount of time associated with using a closed end credit account to process at least one transaction may also be reduced since the at least one transaction is processed in response to the activation of the closed end credit account.

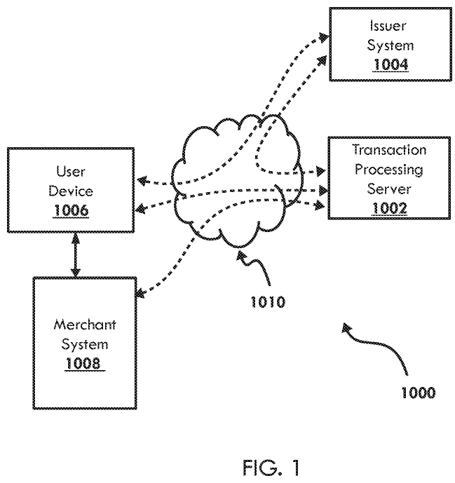

FIG. 1 is a diagram of a non-limiting embodiment of an environment 1000 in which devices, systems, and/or methods, described herein, may be implemented. As shown in FIG. 1, environment 1000 includes transaction processing server 1002, issuer system 1004 user device 1006, merchant system 1008, and network 1010.

Transaction processing server 1002 may include one or more devices capable of receiving information from issuer system 1004, user device 1006, and/or merchant system 1008 via network 1010 and/or communicating information to issuer system 1004, user device 1006, and/or merchant system 1008 via network 1010. For example, transaction processing server 1002 may include a computing device, a server, a group of servers, and/or other like devices. In some non-limiting embodiments, transaction processing server 1002 may be associated with an entity (e.g., a transaction service provider) that operates a credit card network and that processes payments for credit accounts, debit accounts, credit cards, debit cards, and/or the like. In some non-limiting embodiments, transaction processing server 1002 may be associated with a transaction service provider (e.g., a credit card company, a debit card company, and/or the like).

Issuer system 1004 may include one or more devices capable of receiving information from transaction processing server 1002 and/or user device 1006 via a network (e.g., network 1010) and/or communicating information to transaction processing server 1002 and/or user device 1006 via the network. For example, issuer system 1004 may include a computing device, a server, a group of servers, and/or other like devices. In some non-limiting embodiments, issuer system 1004 may be associated with an issuer institution as described herein. For example, issuer system 1004 may be associated with an issuer institution that issued a credit account, debit account, credit card, debit card, and/or the like, to a user associated with user device 1006.

User device 1006 may include one or more devices (e.g., one or more client devices) capable of receiving information from transaction processing server 1002 and/or issuer system 1004 via network 1010 and/or communicating information to transaction processing server 1002 and/or issuer system 1004 via network 1010. User device 1006 may also include a device capable of receiving information from merchant system 1008 via a network (e.g., network 1010), a communication connection (e.g., a near-field communication (NFC) connection, an RFID communication connection, a Bluetooth communication connection, and/or the like), and/or the like, or communicating data (e.g., information) to Merchant system 1008 via the network, the communication connection, and/or the like. For example, user device 1006 may include a client device, a computer device, a desktop computer, a laptop computer, a mobile device, a cellular phone (e.g., a smartphone, standard cellular phone, and/or the like), a portable computer, a wearable device (e.g., a watch, glasses, lenses, clothing, and/or the like), a personal digital assistant (PDA), and/or other like devices. In some non-limiting embodiments, user device 1006 may be capable of engaging in a transaction with Merchant system 1008.

Merchant system 1008 may include one or more devices capable of receiving information from transaction processing server 1002 via network 1010 and/or communicating information to transaction processing server 1002 via network 1010. Merchant system 1008 may also include a device capable of receiving information from user device 1006 via a network (e.g., network 1010), a communication connection (e.g., an NFC communication connection, an RFID communication connection, a Bluetooth communication connection, and/or the like) with user device 1006, and/or the like, and/or communicating information to user device 1006 via the network, the communication connection, and/or the like. In some non-limiting embodiments, merchant system 1008 may include user device 1006.

In some non-limiting embodiments, merchant system 1008 may include one or more devices, computers, computer systems, and/or peripheral devices capable of being used by a merchant to engage in a transaction with a user. Merchant system 1008 may include one or more magnetic stripe card readers, chip card readers, NFC receivers, RFID receivers, and/or other contactless transceivers or receivers, contact-based receivers, payment terminals, computers, servers, input devices, and/or other like devices that can be used to engage in a transaction.

In some non-limiting embodiments, merchant system 1008 may include and/or be in communication with a remote POS system, which may refer to a system that performs the functions of a POS device and is hosted in a network. A remote POS system may be hosted on one or more computers instead of, or in addition to, a physical POS device at a merchant location (e.g., a retail store, and/or the like). A remote POS system may be hosted in or external to the merchant location. As an example, a remote POS system may be a virtual POS system hosted in a cloud-computing environment (e.g., a cloud POS system). The remote POS system may be unique to a specific merchant and may be hosted by the merchant, by a transaction service provider, by an issuer institution, and/or by a third party.

In some non-limiting embodiments, merchant system 1008 may include a client system, a merchant POS system, an acquirer server of an acquirer, a user device (e.g., a mobile device) associated with a user, a payment facilitator server of a payment facilitator, such as but not limited to a payment gateway, a combination thereof, and/or the like. In some non-limiting embodiments, merchant system 1008 may communicate with transaction processing server 1002 to process a transaction.

Network 1010 may include one or more wired and/or wireless networks. For example, network 1010 may include a cellular network (e.g., a long-term evolution (LTE) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

In some non-limiting embodiments, a user may initiate a transaction with merchant system 1008 via user device 1006. The transaction may be a transaction in exchange for products (e.g., goods and/or services) provided by a merchant associated with merchant system 1008. The transaction may be initiated using a portable financial device held by the user and accepted by merchant system 1008. In some non-limiting embodiments, the transaction may be a purchase of a product by the user from the merchant using a credit card, debit card, and/or electronic wallet application accepted by merchant system 1008. For instance, the transaction may be conducted between the user and merchant system 1008 at a merchant brick-and-mortar location, on a merchant website, or via an application (e.g., a mobile device application, a web application, and/or the like) associated with the merchant. Further, it will be appreciated that the user and/or merchant system 1008 may initiate the transaction through any suitable channel.

With continued reference to FIG. 1, merchant system 1008 may communicate transaction messages to one or more transaction processing servers 1002 (e.g., a transaction processing server associated with a transaction service provider). In some non-limiting embodiments, merchant system 1008 may include a device that is part of an acquirer system of an acquirer, such as an acquirer server. In some non-limiting embodiments, merchant system 1008 may include a device (e.g., a payment gateway) that is part of a system of some other payment facilitator operating between a user and transaction processing server 1002. In some non-limiting embodiments, merchant system 1008 may include user device 1006 associated with a user (e.g., a mobile device operated by a user, and/or the like). In some non-limiting embodiments, merchant system 1008 may process transactions initiated using a user's portable financial device by generating a transaction message and communicating the transaction message to transaction processing server 1002. By generating and communicating the transaction message, transaction processing server 1002 facilitates processing of the transaction, where processing of the transaction may include authorization, clearing, and settlement of the transaction.

In some non-limiting embodiments, the transaction may be authorized by communicating transaction data to an acquirer server. For example, an authorization request (e.g., a request including the transaction data) may be communicated to the acquirer server so that the sale may be permitted to proceed. The authorization request may be transmitted from transaction processing server 1002 to issuer system 1004 (e.g., an issuer system associated with an issuer institution) to authorize or deny the transaction. In some non-limiting embodiments, the transaction may be cleared by an acquirer server collecting transactions sent from merchant system 1008, such as all transactions for a particular day or other time period, and submitting those transactions to issuer system 1004 (e.g., an issuer system associated with an entity that issued an account involved in at least one of the transactions). Issuer system 1004, after subtracting out any fees, may communicate a transaction value (e.g., the sum of the transaction amounts of the transactions that issuer system 1004 received from the acquirer server) to the acquirer server and issuer system 1004 may debit (e.g., subtract) each account (e.g., a user account of a user involved in a transaction) corresponding to each of the transactions accordingly. In some non-limiting embodiments, a transaction may be settled by the acquirer associated with the acquirer server subtracting out fees from the transaction value that the acquirer received from issuer system 1004 and communicating and/or allocating the remainder to merchant system 1008.

With continued reference to FIG. 1, merchant system 1008 may communicate a transaction message corresponding to a transaction (e.g., a transaction between merchant system 1008 and a user). For example, merchant system 1008 may communicate a transaction message including transaction data of the transaction. In some non-limiting embodiments, the transaction message may be communicated over network 1010 (e.g., a public internet connection, the Internet, and/or the like). For example, the transaction message may be communicated over the internet using an Application Programming Interface (API) provided by transaction processing server 1002. In some non-limiting embodiments, the API may be a representational state transfer (REST) API provided by transaction processing server 1002. Further, it will be appreciated that various other interfaces may be used. Merchant system 1008 may access the API using any means, including using a website, a mobile device application, and/or the like. Various custom applications and/or systems developed and/or offered by merchant system 1008, transaction processing server 1002, and/or issuer system 1004 may utilize the APIs to facilitate (e.g., process, authorize, clear, settle, and/or the like) a transaction. In some non-limiting embodiments, a transaction message may be communicated over the Internet such that specialized hardware for communicating a transaction message over a private network may not be needed.

With continued reference to FIG. 1, transaction processing server 1002 may communicate with issuer system 1004 and/or an acquirer server in connection with a transaction message received from merchant system 1008. In some non-limiting embodiments, transaction processing server 1002 may communicate with issuer system 1004 for processing a transaction corresponding to a transaction message. Additionally or alternatively, transaction processing server 1002 may communicate with the acquirer server to communicate settlement reports and other processed or unprocessed data associated with processing the transaction corresponding to the transaction message.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 1000 may perform one or more functions described as being performed by another set of devices of environment 1000.

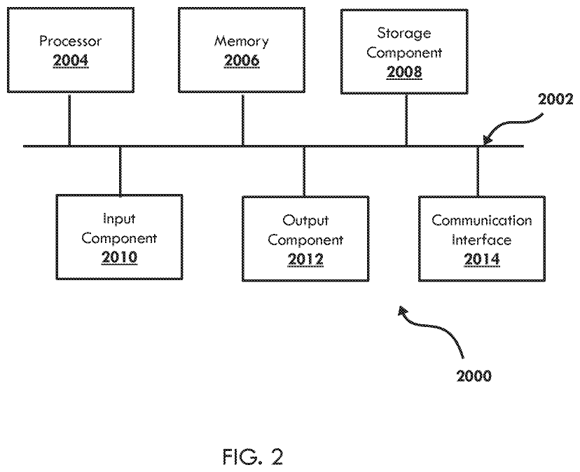

Referring now to FIG. 2, FIG. 2 is a diagram of example components of a device 2000. Device 2000 may correspond to transaction processing server 1002, issuer system 1004, user device 1006, and/or merchant system 1008. In some non-limiting embodiments, transaction processing server 1002, issuer system 1004, user device 1006, and/or merchant system 1008 may include at least one device 2000 and/or at least one component of device 2000. As shown in FIG. 2, device 2000 may include bus 2002, processor 2004, memory 2006, storage component 2008, input component 2010, output component 2012, and communication interface 2014.

Bus 2002 may include a component that permits communication among the components of device 2000. In some non-limiting embodiments, processor 2004 may be implemented in hardware, firmware, or a combination of hardware and software. For example, processor 2004 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like) that can be programmed to perform a function. Memory 2006 may include a random access memory (RAM), a read only memory (ROM), and/or another type of dynamic or static storage device (e.g., a flash memory, a magnetic memory, an optical memory, and/or the like) that stores information and/or instructions for use by processor 2004.

Storage component 2008 may store information and/or software related to the operation and use of device 2000. For example, storage component 2008 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 2010 may include a component that permits device 2000 to receive information, such as via user input (e.g., a touch screen display, a keyboard, a keypad, a mouse, a button, a switch, a microphone, and/or the like). Additionally, or alternatively, input component 2010 may include a sensor for sensing information (e.g., a global positioning system (GPS) component, an accelerometer, a gyroscope, an actuator, and/or the like). Output component 2012 may include a component that provides output information from device 2000 (e.g., a display, a speaker, one or more light-emitting diodes (LEDs), and/or the like).

Communication interface 2014 may include a transceiver-like component (e.g., a transceiver, a separate receiver and transmitter, and/or the like) that enables device 2000 to communicate with other devices, such as via a wired connection, a wireless connection, or a combination of wired and wireless connections.

Communication interface 2014 may permit device 2000 to receive information from another device and/or provide information to another device. For example, communication interface 2014 may include an Ethernet interface, an optical interface, a coaxial interface, an infrared interface, a radio frequency (RF) interface, a universal serial bus (USB) interface, a Wi-Fi interface, a cellular network interface, and/or the like.

Device 2000 may perform one or more processes described herein. Device 2000 may perform these processes in response to processor 2004 executing software instructions stored by a non-transitory computer-readable medium, such as memory 2006 and/or storage component 2008. A computer-readable medium is defined herein as a non-transitory memory device. A memory device includes memory space located inside of a single physical storage device or memory space spread across multiple physical storage devices.

Software instructions may be read into memory 2006 and/or storage component 2008 from another computer-readable medium or from another device via communication interface 2014. When executed, software instructions stored in memory 2006 and/or storage component 2008 may cause processor 2004 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 2000 may include additional components, fewer components, different components, or differently arranged components than those shown in FIG. 2. Additionally, or alternatively, a set of components (e.g., one or more components) of device 2000 may perform one or more functions described as being performed by another set of components of device 2000.

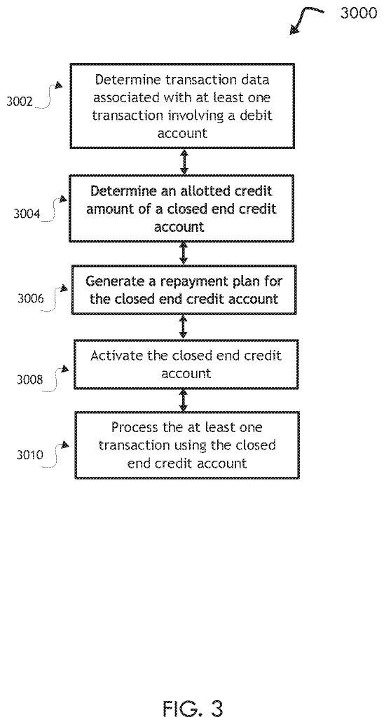

Referring now to FIG. 3, FIG. 3 is a flowchart of a non-limiting embodiment of a process 3000 for providing a closed end credit account associated with a debit account. One or more of the steps of process 3000 may be performed (e.g., completely, partially, and/or the like) by transaction processing server 1002. Additionally or alternatively, one or more of the steps of process 3000 may be performed (e.g., completely, partially, and/or the like) by another device or a group of devices separate from or including transaction processing server 1002, such as issuer system 1004, user device 1006, and/or merchant system 1008.

As shown in FIG. 3, at step 3002, process 3000 includes determining at transaction data of at least one transaction involving a debit account. For example, transaction processing server 1002 may determine transaction data of at least one transaction involving a debit account of a user associated with user device 1006. In some non-limiting embodiments,

In some non-limiting embodiments, transaction data of a transaction may include a transaction amount (e.g., a total cost of the at least one transaction, an individual cost of each product involved in the transaction, and/or the like) of a transaction, transaction identity data (e.g., a unique identifier, a reference number associated with a transaction, a transaction identifier, a transaction id, a unique transaction identifier (UTI), a merchant order number, and/or the like) of a transaction, product data (e.g., product identification data, a name of the product, a name of the type of product, a stock keeping unit (SKU) number associated with the product, a merchant code associated with the product, and/or the like) of a transaction, timing data (e.g., a time of day, a time range of a day, a day of the week, a day of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like, and/or the like) of a transaction, transaction type data (e.g., an online transaction, a card present transaction, a face to face transaction, and/or the like) of a transaction, transaction status data (e.g., completed, incomplete, processed, unprocessed, and/or the like) of a transaction, and/or the like.

Additionally or alternatively, the transaction data may include user transaction data of a user, merchant transaction data of a merchant, issuer institution transaction data of an issuer institution that issued the debit account involved in a transaction, and/or the like. In some non-limiting embodiments, user transaction data may include user identity data (e.g., a unique identifier of a user, a name of a user, and/or the like) of a user, user account identity data (e.g., an account identifier for an account of a user, a PAN for a credit and/or debit account of a user, a token associated with a credit and/or debit account of a user, and/or the like) of a user, and/or the like. In some non-limiting embodiments, merchant transaction data may include merchant identity data (e.g., an identifier of a merchant, a unique identifier of a merchant, a name of a merchant, and/or the like) of a merchant, merchant category data (e.g., an identifier for a merchant category of a merchant, a code for a merchant category of a merchant, a name of a merchant category of a merchant, a type of a merchant category of a merchant, and/or the like) of a merchant, merchant account identity data (e.g., an account identifier for an account of a merchant, a PAN for an account of a merchant, a token for an account of a merchant, and/or the like) associated with the merchant. In some non-limiting embodiments, issuer institution transaction data may include issuer institution identity data (e.g., a unique identifier, a name, an Issuer Identification Number (IIN), a Bank Identification Number (BIN), and/or the like) associated with the issuer institution that issued the debit account involved in the at least one transaction, and/or the like.

In some non-limiting embodiments, transaction processing server 1002 may receive transaction data of at least one transaction involving the debit account. For example, transaction processing server 1002 may receive transaction data of at least one transaction involving the debit account before determining the transaction data (e.g., at least one transaction data parameter, a transaction amount, user identity data, merchant identity data, issuer institution identity data, and/or the like) of the at least one transaction. In some non-limiting embodiments, the at least one transaction may be a past transaction (e.g., a transaction that was processed, a transaction that was settled, and/or the like) between a user (e.g., at least one user, a plurality of users, and/or the like) and a merchant (e.g., at least one merchant, a plurality of merchants, and/or the like) that involved a debit account of the user. In some non-limiting embodiments, the user may be associated with user device 1006 (e.g., the user may have the ability to initiate actions via user device 1006).

In some non-limiting embodiments, transaction processing server 1002 may receive transaction data of at least one transaction from issuer system 1004, user device 1006, and/or merchant system 1008. For example, transaction processing server 1002 may receive the transaction data before, during, or after the at least one transaction, where the transaction data is communicated by merchant system 1008. In some non-limiting embodiments, transaction processing server 1002 may receive the transaction data of the at least one transaction from user device 1006 in response to a user selection from the user. For example, user device 1006 may display a user interface to the user that includes a plurality of transactions (e.g., a list of transactions, a chart of transactions, and/or the like). The user may select, via the user interface, at least one transaction of the plurality of transactions, and user device 1006 may communicate the transaction data of the at least one transaction to transaction processing server 1002. Transaction processing server 1002 may receive the transaction data in response to user device 1006 communicating the transaction data.

In some non-limiting embodiments, transaction processing server 1002 may determine (e.g., automatically) that transaction data of at least one transaction corresponds with predetermined transaction criteria. For example, transaction processing server 1002 may use predetermined transaction criteria to determine if the at least one transaction is eligible to be associated with a closed end credit account (e.g., a closed end credit account that is to be and/or was provided to the user). Accordingly, transaction processing server 1002 may compare the transaction data of the at least one transaction to predetermined transaction criteria to determine whether the at least one transaction corresponds with the predetermined transaction criteria. If the transaction data corresponds with the predetermined transaction criteria, the at least one transaction may be determined to be eligible to be associated with a closed end credit account. If the transaction data does not correspond with the predetermined transaction criteria, the at least one transaction may be determined to not be eligible to be associated with a closed end credit account. In some non-limiting embodiments, the at least one transaction may be associated with the closed end credit account so that an allotted credit amount of the closed end credit account is equal to, less than, or greater than a transaction amount of the at least one transaction.

In some non-limiting embodiments, transaction processing server 1002 may communicate a message (e.g., a notification, a notification message, a text message, an SMS message, an alert, and/or the like) based on determining that the transaction data of at least one transaction corresponds with the to the predetermined transaction criteria. For example, transaction processing server 1002 may communicate an alert that indicates that the transaction data of at least one transaction corresponds or does not correspond to the predetermined transaction criteria. In some non-limiting embodiments, transaction processing server 1002 may communicate the message to user device 1006.

In some non-limiting embodiments, the predetermined transaction criteria may include predetermined transaction amount data (e.g., a predetermined threshold value for a transaction amount of a transaction, a predetermined maximum threshold value of a transaction amount of a transaction, a predetermined minimum threshold value of a transaction amount of a transaction, and/or the like) associated with at least one transaction, predetermined timing data (e.g., a predetermined time of a day, a predetermined time range of a day, a predetermined day of a week, a predetermined month of a year, a predetermined threshold value of an amount of time since a transaction was initiated, processed, authorized, cleared, settled, and/or the like) associated with at least one transaction, predetermined product data (e.g., a name of a product involved in a transaction, a type of a product involved in a transaction, and/or the like) associated with at least one transaction, and/or the like.

Additionally or alternatively, the predetermined transaction criteria may include predetermined user identity data (e.g., a predetermined identifier of a user, a predetermined name of a user, and/or the like) associated with a user, predetermined merchant identity data (e.g., a predetermined identifier of a merchant, a predetermined name of a merchant, and/or the like) associated with a merchant, predetermined merchant category data (e.g., a predetermined identifier for a merchant category of a merchant, a predetermined name for a merchant category of a merchant, a predetermined code for a merchant category of a merchant, and/or the like) associated with a merchant, predetermined issuer institution identity data (e.g., a predetermined identifier of an issuer institution, a predetermined name of an issuer institution, a predetermined range of issuer institution identifiers, a predetermined range of issuer institution BINs, predetermined range of issuer institution IINs, and/or the like) associated with an issuer institution, and/or the like.

In some non-limiting embodiments, transaction processing server 1002 may receive the predetermined transaction criteria. For example, transaction processing server 1002 may receive the predetermined transaction criteria from issuer system 1004, user device 1006, and/or merchant system 1008. In some non-limiting embodiments, the predetermined transaction criteria may be provided by a user associated with user device 1006. In some non-limiting embodiments, the predetermined transaction criteria may be provided by an entity associated with merchant system 1008 (e.g., a merchant) and/or issuer system 1004 (e.g., an issuer institution). In some non-limiting embodiments, the predetermined transaction criteria may be received before, during, or after transaction data is received by transaction processing server 1002.

In some non-limiting embodiments, transaction processing server 1002 may receive transaction data of a plurality of transactions and determine whether at least one transaction of the plurality of transactions corresponds with the predetermined transaction criteria. For example, transaction processing server 1002 may receive first transaction data of a first transaction and second transaction data of a second transaction in response to a user selecting the at least one first transaction and the at least one second transaction via a user interface displayed on user device 1006. Transaction processing server 1002 may determine that the first transaction data and the second transaction data correspond to the predetermined transaction criteria. Alternatively, transaction processing server 1002 may determine that the first transaction data, the second transaction data, or the first transaction data and the second transaction data do not correspond to the predetermined transaction criteria. In some non-limiting embodiments, transaction processing server 1002 may communicate a message (e.g., a notification message) that indicates that the first transaction data and/or the second transaction data corresponds or does not correspond to the predetermined transaction criteria.

In some non-limiting embodiments, transaction processing server 1002 may receive initiation data (e.g., an input from the user indicating that the user desires to activate a closed end credit account) to initiate activation of a closed end credit account. For example, transaction processing server 1002 may receive an input from a user via a user interface displayed on user device 1006 to initiate activation of the closed end credit account. In some non-limiting embodiments, transaction processing server 1002 may receive the initiation data before, during, or after receiving the transaction data of the at least one transaction. In some non-limiting embodiments, transaction processing server 1002 may not receive the transaction data of the at least one transaction unless the initiation data is received first.

In some non-limiting embodiments, transaction processing server 1002 may cause a user interface to be displayed by user device 1006. For example, transaction processing server 1002 may cause a user interface to be displayed that includes data communicated to user device 1006 by transaction processing server 1002. In some non-limiting embodiments, transaction processing server 1002 may cause a user interface to be displayed by user device 1006 that includes a user selectable element. For example, transaction processing server 1002 may cause a user interface to be displayed by user device 1006 that includes a user selectable element, the activation of which causes initiation data to be communicated to transaction processing server 1002 for initiating activation of the closed end credit account. Transaction processing server 1002 may receive the initiation data from user device 1006 in response to (e.g., after) the user selecting the user selectable element of the user interface.

In some non-limiting embodiments, transaction processing server 1002 may determine (e.g., automatically) whether to activate a closed end credit account. For example, transaction processing server 1002 may determine whether to activate the closed end credit account based on the transaction data of the at least one transaction. In such an example, transaction processing server 1002 may determine whether to activate the closed end credit account based on the transaction amount, product data, timing data, or any combination thereof, of a transaction. Additionally or alternatively, transaction processing server 1002 may determine whether to activate the closed end credit account based on at least one of the following: user data (e.g., user identity data), merchant data (e.g., merchant identity data), issuer institution data (e.g., issuer institution identity data), or any combination thereof. For example, transaction processing server 1002 may determine to activate the closed end credit account for a user based on the name of a user involved in a transaction, the name of a merchant involved in a transaction, and/or the name of an issuer institution that issued a debit account that is involved in a transaction.

User data may include user transaction data of a user, user identity data of a user, user account identity data of a user, user account balance data (e.g., an account balance of a credit and/or debit account of a user, an average account balance of a credit and/or debit account of a user, an account balance of a credit and/or debit account of a user over a predetermined time range, and/or the like) of a user, past user transaction data (e.g., transaction data of past transactions involving a user, a number of past transactions involving an account of a user, a number of past transactions involving an account of the user that was processed successfully, and/or the like) of the user, user credit data (e.g., a credit rating of a user, a credit score of user, and/or the like) of user, user account balance data of users similar to a user, past user transaction data of users similar to a user, and/or the like.

Merchant data may include merchant transaction data of a merchant, merchant identity data (e.g., a unique identifier of a merchant, a name of a merchant, and/or the like) of a merchant, merchant category data (e.g., a code for a merchant category of a merchant, a name for a merchant category of a merchant, a type of a merchant category of a merchant, and/or the like) of a merchant, merchant account identity data (e.g., a PAN associated with an account of a merchant, a token associated with an account of a merchant, and/or the like) of a merchant, and/or the like. Issuer institution data may include issuer institution transaction data of an issuer institution, issuer institution identity data of an issuer institution, and/or the like.

In some non-limiting embodiments, transaction processing server 1002 may determine to activate or not to activate a closed end credit account. In some non-limiting embodiments, transaction processing server 1002 may communicate a message (e.g., a notification message) that indicates that a closed end credit account may or may not be provided in response to determining to activate or not to activate the closed end credit account. For example, transaction processing server 1002 may communicate the message to user device 1006.

In some non-limiting embodiments, transaction processing server 1002 may determine whether to activate a closed end credit account in response to receiving transaction data of at least one transaction. In some non-limiting embodiments, transaction processing server 1002 may determine whether to activate a closed end credit account before receiving transaction data of at least one transaction. For example, transaction processing server 1002 may determine whether to activate the closed end credit account in response to receiving initiation data to initiate activation of the closed end credit account, where the initiation data is received before the transaction data.

In some non-limiting embodiments, transaction processing server 1002 may determine whether to activate a closed end credit account based at least partially on a credit account provision rule, transaction data of at least one transaction, and at least one of the following: user data of a user involved in the at least one transaction, merchant data of a merchant involved in the at least one transaction, issuer institution data of an issuer institution that issued a debit account involved in the at least one transaction, or any combination thereof. For example, transaction processing server 1002 may determine whether to activate the closed end credit account by comparing the transaction data of the at least one transaction and at least one of the following: the merchant data, the user data, the issuer institution data, or any combination thereof, to credit account provision criteria of the credit account provision rule.

In some non-limiting embodiments, transaction processing server 1002 may determine user data of a user involved in a transaction, merchant data of a merchant involved in a transaction, and/or issuer institution data of an issuer institution that issued a debit account involved in a transaction. For example, transaction processing server 1002 may compare user identity data, merchant identity data, and/or issuer institution identity data included with transaction data of a transaction to entries in data structure that stores the user data, the merchant data, and/or the issuer institution. Accordingly, transaction processing server 1002 may retrieve the user data, the merchant data, and/or the issuer institution from the corresponding locations in the data structure.

In some non-limiting embodiments, the at least one credit account provision rule may include credit account provision criteria. The credit account provision criteria may include predetermined transaction amount data (e.g., a predetermined threshold value for a transaction amount of a transaction, a predetermined maximum threshold value of a transaction amount of a transaction, a predetermined minimum threshold value of a transaction amount of a transaction, and/or the like) associated with at least one transaction, predetermined timing data (e.g., a predetermined time of a day, a predetermined time range of a day, a predetermined day of a week, a predetermined month of a year, a predetermined threshold value of an amount of time since a transaction was initiated, processed, authorized, cleared, settled, and/or the like) associated with at least one transaction, predetermined product data (e.g., a predetermined name of a product involved in a transaction, a predetermined type of a product involved in a transaction, and/or the like) associated with at least one transaction, and/or the like.

Additionally or alternatively, the credit account provision criteria may include predetermined merchant data (e.g., predetermined merchant identity data, a predetermined identifier of a merchant, a predetermined name of a merchant, predetermined merchant category data, a predetermined identifier for a merchant category of a merchant, a predetermined name for a merchant category of a merchant, a predetermined code for a merchant category of a merchant, and/or the like) associated with a merchant, predetermined user data (e.g., predetermined user identity data of a user, user account identity data of a user, predetermined user account balance data of a user, an predetermined account balance of a credit and/or debit account of a user, an predetermined average account balance of a credit and/or debit account of a user, an predetermined account balance of a credit and/or debit account of a user over a predetermined time range, predetermined past user transaction data, predetermined transaction data of past transactions involving a user, a predetermined number of past transactions involving an account of a user, a predetermined number of past transactions involving an account of the user that was processed successfully, predetermined user credit data of the user, a predetermined credit rating of a user, a predetermined credit score of user, predetermined user account balance data of users similar to a user, predetermined past user transaction data of users similar to a user, and/or the like) associated with a user, predetermined issuer institution data (e.g., predetermined issuer institution identity data, a predetermined identifier of an issuer institution, a predetermined name of an issuer institution, a predetermined range of issuer institution identifiers, a predetermined range of issuer institution BINs, predetermined range of issuer institution IINs, and/or the like) associated with an issuer institution, or any combination thereof.

In some non-limiting embodiments, transaction processing server 1002 may receive the credit account provision criteria from issuer system 1004, user device 1006, and/or merchant system 1008. In some non-limiting embodiments, the credit account provision criteria may be the same as, different from, or the same as a portion of the predetermined transaction criteria.

In some non-limiting embodiments, transaction processing server 1002 may utilize a model to determine whether to activate the closed end credit account. For example, transaction processing server 1002 may utilize a machine learning model, a pattern matching model, a credit account provision model (e.g., a customized model developed for a particular subset of transactions, such as transactions involving a particular user, a particular merchant, a particular issuer institution, any combination thereof, and/or the like), and/or the like. In such an example, transaction processing server 1002 may utilize the model to process transaction data, user data, merchant data, issuer institution data, or a combination thereof, and determine whether to activate a closed end credit account and/or determine a set of parameters (e.g., credit account provision criteria of the credit account provision rule) associated with determining to activate a closed end credit account. In some implementations, transaction processing server 1002 may obtain the model from a data storage device. For example, transaction processing server 1002 may generate (e.g., automatically) the machine learning model for determining a set of parameters associated with determining to activate a closed end credit account, and may store the machine learning model via a data structure for utilization in a response to a request for data identifying the set of parameters associated with determining to activate a closed end credit account.

In some implementations, transaction processing server 1002 may generate a model to determine whether to activate a closed end credit account and/or determine a set of parameters associated with determining whether to activate a closed end credit account. For example, when transaction processing server 1002 determines to utilize a machine learning model, transaction processing server 1002 may utilize a first portion of past user transaction data as a training set for determining whether to activate a closed end credit account and/or determining a set of parameters associated with determining whether to activate a closed end credit account, and may utilize a second portion of past user transaction data as a validation set (e.g., for validating accuracy of a determination whether to activate a closed end credit account and/or a determination of a set of parameters associated with determining whether to activate a closed end credit account). In this case, transaction processing server 1002 may apply the machine learning model to the transaction data of the at least one transaction to determine whether to activate a closed end credit account.

Machine learning techniques used to generate the model may include, for example, supervised and/or unsupervised techniques, such as those involving artificial neural networks, association rule learning, Bayesian networks, clustering, deep learning, decision trees, genetic algorithms, Hidden Markov Modeling, inductive logic programming, learning automata, learning classifier systems, logistic regressions, linear classifiers, quadratic classifiers, reinforcement learning, representation learning, rule-based machine learning, similarity and metric learning, sparse dictionary learning, support vector machines, and/or the like. In some non-limiting embodiments, the training data used to train the machine learning model may be different from the training data used to validate the machine learning model.

In some non-limiting embodiments, transaction processing server 1002 may determine whether to activate a closed end credit account in response to determining that the transaction data of the at least one transaction corresponds with the predetermined transaction criteria. In some non-limiting embodiments, transaction processing server 1002 may determine whether to activate a closed end credit account based on the same, different, or a portion of the data used to determine whether the at least one transaction corresponds with the predetermined transaction criteria.

In some non-limiting embodiments, transaction processing server 1002 may communicate an offer message in response to determining to activate the closed end credit account. For example, transaction processing server 1002 may communicate the offer message to user device 1006. In some non-limiting embodiments, the offer message may include an offer to activate a closed end credit account.

As further shown in FIG. 3, at step 3004, process 3000 includes determining an allotted credit amount of the closed end credit account. For example, transaction processing server 1002 may determine (e.g., automatically) an allotted credit amount (e.g., a total amount of funds) for the closed end credit account. In some non-limiting embodiments, the allotted credit amount may be determined based on a transaction amount of the at least one transaction. For example, the allotted credit amount may be determined to be less than, equal to, or greater than the transaction amount of the at least one transaction. In some non-limiting embodiments, the allotted credit amount may be determined based at least partially on user data of the user involved in the at least one transaction. For example, the allotted credit amount may be determined to be less than, equal to, or greater than the transaction amount of the at least one transaction based on user data of a user.

In some non-limiting embodiments, transaction processing server 1002 may determine the allotted credit amount based at least partially on at least one credit allotment rule and at least one of the following: the transaction data of the at least one transaction, merchant data, user data, issuer institution data, or any combination thereof. For example, transaction processing server 1002 may determine that the allotted credit amount is equal to a specific amount based on the identity of a merchant involved in the transaction, the identity and credit rating of a user involved in the transaction, and a transaction amount of the transaction. In another example, transaction processing server 1002 may determine that the allotted credit amount is equal to a specific amount based on an average account balance of a debit account of a user. In some non-limiting embodiments, transaction processing server 1002 may determine the allotted credit amount based on the same, different, or a portion of the data used to determine whether to activate the closed end credit account and/or the data used to determine whether the at least one transaction corresponds with the predetermined transaction criteria.

In some non-limiting embodiments, the at least one credit allotment rule may include credit allotment criteria associated with predetermined merchant data, predetermined user data, predetermined issuer institution data, or any combination thereof. In some non-limiting embodiments, transaction processing server 1002 may receive the credit allotment criteria from issuer system 1004, user device 1006, and/or merchant system 1008. In some non-limiting embodiments, the credit allotment criteria may be the same as, different from, or the same as a portion of the predetermined transaction criteria, and/or the credit account provision criteria.

In some non-limiting embodiments, transaction processing server 1002 may communicate the allotted credit amount of the closed end credit account. For example, transaction processing server 1002 may communicate the allotted credit amount to user device 1006 in response to determining the allotted credit amount. In some non-limiting embodiments, transaction processing server 1002 may include the allotted credit amount in an offer message that also includes an offer to activate a closed end credit account.

As further shown in FIG. 3, at step 3006, process 3000 includes generating at least one repayment plan for the closed end credit account. For example, transaction processing server 1002 may generate (e.g., automatically) at least one repayment plan for the closed end credit account in response to determining to activate the closed end credit. In some non-limiting embodiments, transaction processing server 1002 may generate at least one repayment plan for the closed end credit account in response to determining the allotted credit amount of the closed end credit account. The at least one repayment plan may include repayment plan parameters for the closed end credit account, such as an interest rate of the closed end credit account, an overall time interval for repayment of the closed end credit account (e.g., a term of the closed end credit account, a time limit of the closed end credit account, a month, a plurality of months, a year, and/or the like), a date by which repayment of the closed end credit account must be complete (e.g., a specific date, and/or the like), a payment amount for each period of the overall time interval for repayment of the closed end credit account (e.g., monthly payments, weekly payments, and/or the like), and/or an overall payment amount of the closed end credit account (e.g., a total of the payment amounts for each period of the overall time interval and an interest amount associated with the closed end credit account). In some non-limiting embodiments, the at least one repayment plan may include a plurality of repayment plans, where each or at least one of the plurality of repayment plans may have different repayment plan parameters for the closed end credit account than other repayment plans.

In some non-limiting embodiments, transaction processing server 1002 may generate the at least one repayment plan based at least partially on at least one repayment rule and at least one of the following: transaction data of the at least one transaction, merchant data, user data, issuer institution data, or any combination thereof. In some non-limiting embodiments, transaction processing server 1002 may generate at least one repayment plan based on the same, different, or a portion of the data used to determine whether the at least one transaction corresponds with the predetermined transaction criteria, the data used to determine whether to activate the closed end credit account, and/or the data used to determine the allotted credit amount for the closed end credit account.

In some non-limiting embodiments, the repayment plan rule may include repayment plan criteria associated with predetermined merchant data, predetermined user data, predetermined issuer institution data, or any combination thereof. For example, the repayment plan criteria may specify repayment plan parameters of the at least one repayment plan based on predetermined merchant data, predetermined user data, predetermined issuer institution data, or any combination thereof. In some non-limiting embodiments, transaction processing server 1002 may receive the repayment plan criteria from issuer system 1004, user device 1006, and/or merchant system 1008. In some non-limiting embodiments, the repayment plan criteria may be the same as, different from, or the same as a portion of the predetermined transaction criteria, the credit account provision criteria, and/or the credit allotment criteria.

In some non-limiting embodiments, transaction processing server 1002 may utilize a model to generate the at least one repayment plan. For example, transaction processing server 1002 may utilize a machine learning model, a pattern matching model, a repayment plan model (e.g., a customized model developed for a particular subset of transactions, such as transactions involving a particular user, a particular merchant, a particular issuer institution, any combination thereof, and/or the like), and/or the like. In such an example, transaction processing server 1002 may utilize the model to process transaction data, user data, merchant data, issuer institution data, or a combination thereof, and generate the at least one repayment plan and/or determine a set of parameters (e.g., repayment plan criteria of the repayment plan rule) associated with generating the at least one repayment plan. In some implementations, transaction processing server 1002 may obtain the model from data storage. For example, transaction processing server 1002 may generate (e.g., automatically) the machine learning model for determining a set of parameters associated with generating the at least one repayment plan, and may store the machine learning model via a data structure for utilization in a response to a request for data identifying the set of parameters associated with generating the at least one repayment plan.

In some implementations, transaction processing server 1002 may generate a model to generate the at least one repayment plan and/or determine a set of parameters associated with generating the at least one repayment plan. For example, when transaction processing server 1002 determines to utilize a machine learning model, transaction processing server 1002 may utilize a first portion of past user transaction data as a training set for generating the at least one repayment plan and/or determining a set of parameters associated with generating the at least one repayment plan, and may utilize a second portion of past user transaction data as a validation set (e.g., for validating accuracy of the generation of the at least one repayment plan and/or the determination of the set of parameters associated with generating the at least one repayment plan). In one example, transaction processing server 1002 may apply the machine learning model to the transaction data of the at least one transaction, the user data, the merchant data, the issuer institution data, or any combination thereof to generate the at least one repayment plan.

Machine learning techniques used to generate the model may include, for example, supervised and/or unsupervised techniques, such as those involving artificial neural networks, association rule learning, Bayesian networks, clustering, deep learning, decision trees, genetic algorithms, Hidden Markov Modeling, inductive logic programming, learning automata, learning classifier systems, logistic regressions, linear classifiers, quadratic classifiers, reinforcement learning, representation learning, rule-based machine learning, similarity and metric learning, sparse dictionary learning, support vector machines, and/or the like. In some non-limiting embodiments, the training data used to train the machine learning model may be different from the training data used to validate the machine learning model.

In some non-limiting embodiments, transaction processing server 1002 may communicate repayment plan parameters of the at least one repayment plan to user device 1006. In some non-limiting embodiments, transaction processing server 1002 may communicate the repayment plan parameters in response to generating the at least one repayment plan. In some non-limiting embodiments, transaction processing server 1002 may communicate a message (e.g., a notification message) that includes the repayment plan parameters of the at least one repayment plan. For example, transaction processing server 1002 may communicate the message to user device 1006.

In some non-limiting embodiments, transaction processing server 1002 may communicate the repayment plan parameters by causing a user interface to be displayed that includes the repayment plan parameters of the at least one repayment plan. For example, transaction processing server 1002 may communicate the repayment plan parameters to user device 1006 and user device 1006 may provide a user interface that displays the at least one repayment plan to a user. In some non-limiting embodiments, the user interface may include at least one selectable element that allows a user to select the at least one repayment plan. For example, user device 1006 may display a user interface that includes a plurality of selectable elements, each of which is associated with a repayment plan of a plurality of repayment plans. The user interface may provide the user with the ability to select one of the selectable elements, which may cause user device 1006 to communicate repayment plan parameters of the repayment plan that was selected and transaction processing server 1002 to receive the repayment plan parameters associated with the repayment plan that was selected.

In some non-limiting embodiments, transaction processing server 1002 may receive acceptance data that indicates acceptance of the at least one repayment plan by the user, where the acceptance data is received from user device 1006. In some non-limiting embodiments, the acceptance data may be received by transaction processing server 1002 in response to a user's input that is provided via a user interface rendered on user device 1006. For example, transaction processing server 1002 may cause a user interface to be displayed on user device 1006. The user interface may include a plurality of selectable elements, where each of the plurality of selectable elements is associated with a repayment plan of a plurality of repayment plans. Transaction processing server 1002 may receive acceptance data associated with acceptance by the user of a repayment plan of the plurality of repayment plans in response to the user selecting a user selectable element associated with that repayment plan.

As further shown in FIG. 3, at step 3008, process 3000 includes activating the closed end credit account. For example, transaction processing server 1002 may activate the closed end credit account in response to receiving acceptance data (e.g., acceptance data that indicates acceptance of the at least one repayment plan, acceptance data that indicates acceptance of an offer to activate the closed end credit account, and/or the like). In some non-limiting embodiments, transaction processing server 1002 may activate the closed end credit account in response to receiving a response to an offer message that includes an offer to activate a closed end credit account. For example, transaction processing server 1002 may communicate the offer message to user device 1006 in response to determining to activate the closed end credit account. Transaction processing server 1002 may receive a response to the offer message that indicates a user associated with user device 1006 accepted the offer to activate the closed end credit account or declined the offer to activate the closed end credit account.

In some non-limiting embodiments, transaction processing server 1002 may activate the closed end credit by generating an account identifier for the closed end credit account. For example, transaction processing server 1002 may generate a PAN that may be provided by a user during a transaction so that the transaction may be processed using the PAN.

In some non-limiting embodiments, transaction processing server 1002 may link the closed end credit account or may cause the closed end credit account to be associated with the debit account. In some non-limiting embodiments, transaction processing server 1002 may link the closed end credit account to the debit account so that the closed end credit account may be accessed by a user when the user accesses the debit account. For example, when a user accesses the debit account via a software application (e.g., a web application, a mobile application, and/or the like), the user may access the closed end credit account via the same application. In addition, the user may be able to perform actions associated with the closed end credit account, including communicating with an entity (e.g., a lender, an issuer institution) that manages (e.g., issues, authorizes, and/or the like) the closed end credit account, making a payment for the closed end credit account based on the at least one repayment plan (e.g., using the debit account, using a credit and/or debit card, and/or the like), associating at least one additional transaction with the closed end credit account, and/or the like. In some non-limiting embodiments, transaction processing server 1002 may cause the actions associated with the closed end credit account to be performed. For example, transaction processing server 1002 may cause a payment (e.g., a transfer of funds from the debit account of the user) to be applied to the closed end credit account based on the at least one repayment plan (e.g., according to the payment amount for each period of the overall time interval for repayment of the closed end credit account).

In some non-limiting embodiments, by linking the closed end credit account to the debit account, transaction processing server 1002 may allow the closed end credit account to be utilized during processing of a transaction involving the debit account of the user. In some non-limiting embodiments, by linking the closed end credit account, transaction processing server 1002 may allow additional transactions (e.g., additional past transactions) to be associated with the closed end credit account.

In some non-limiting embodiments, transaction processing server 1002 may repeat steps 3004-3008 of process 3000 in response to receiving transaction data of additional transactions that are to be associated with the closed end credit account. In some non-limiting embodiments, transaction processing server 1002 may allow additional transactions to be associated with another closed end credit account (e.g., a second closed end credit account) that has been activated.

In some non-limiting embodiments, transaction processing server 1002 may cause the closed end credit account to be applied to the debit account by sending a message to issuer system 1004. For example, transaction processing server 1002 may send a message to issuer system 1004 where the message may include an instruction (e.g., a command) to link the allotted credit amount of the closed end credit account to the debit account associated with a user. Issuer system 1004 may link the allotted credit amount of the closed end credit account to the debit account associated with the user in response to receiving the message.

As further shown in FIG. 3, at step 3010, process 3000 includes processing the at least one transaction using the closed end credit account. For example, transaction processing server 1002 may process at least one transaction using the closed end credit account. In some non-limiting embodiments, transaction processing server 1002 may process at least one transaction (e.g., a pending transaction), which is not authorized, not cleared, and/or not settled, using the closed end credit account. For example, transaction processing server 1002 may communicate a message to issuer system 1004 that includes an account identifier associated with the closed end credit account along with transaction data of at least one transaction (e.g., at least one transaction that is not authorized, not cleared, and/or not settled). Issuer system 1004 may receive the message and process the at least one transaction based on the account identifier associated with the closed end credit account along with transaction data of at least one transaction. In some non-limiting embodiments, transaction processing server 1002 may process at least one transaction (e.g., a past transaction), which is authorized, cleared, and/or settled, using the closed end credit account. For example, transaction processing server 1002 may add or cause the allotted credit amount of the closed end credit account to be added to the debit account of the user.

In some non-limiting embodiments, transaction processing server 1002 may determine at least one reward offer (e.g., a discount, a merchant redemption offer, a card holder loyalty program offer, an e-commerce offer, and/or the like) associated with the closed end credit account. For example, transaction processing server 1002 may determine at least one reward based on transaction data of at least one transaction involving the debit account of a user. In some non-limiting embodiments, transaction processing server 1002 may communicate the at least one reward offer in response to receiving payment data associated with the at least one repayment plan. In some non-limiting embodiments, transaction processing server 1002 may communicate an offer to activate an open end credit account. For example, transaction processing server 1002 may communicate an offer to activate an open end credit account in response to receiving payment data associated with the at least one repayment plan.

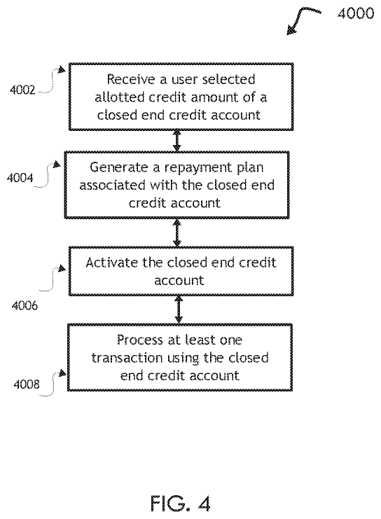

Referring now to FIG. 4, FIG. 4 is a flowchart of another non-limiting embodiment of a process 4000 for providing a closed end credit account associated with a debit account. One or more of the steps of process 4000 may be performed (e.g., completely, partially, and/or the like) by transaction processing server 1002. Additionally or alternatively, one or more of the steps of process 4000 may be performed (e.g., completely, partially, and/or the like) by another device or a group of devices separate from or including transaction processing server 1002, such as issuer system 1004, user device 1006, and/or merchant system 1008.

As shown in FIG. 4, at step 4002, process 4000 includes receiving a user selected allotted credit amount for a closed end credit account. For example, transaction processing server 1002 may receive a user selected allotted credit amount of a closed end credit account. In some non-limiting embodiments, transaction processing server 1002 may cause a user interface to be rendered on user device 1006 that includes a user selectable element, the activation of which causes the credit amount associated with the user selected allotted credit amount to be communicated to transaction processing server 1002. Transaction processing server 1002 may receive the credit amount based on the user selecting the selectable element of the user interface.

In some non-limiting embodiments, transaction processing server 1002 may receive initiation data to initiate activation of the closed end credit account. For example, transaction processing server 1002 may receive the initiation data from user device 1006 before receiving the credit amount. In some non-limiting embodiments, transaction processing server 1002 may cause a user interface to be generated on user device 1006 that includes a user selectable element, the activation of which causes initiation data to be communicated to transaction processing server 1002 for initiating activation of the closed end credit account. Transaction processing server 1002 may receive the initiation data based on the user selecting the selectable element of the user interface.

In some non-limiting embodiments, transaction processing server 1002 may determine whether to activate a closed end credit account (e.g., in the same or similar fashion as described above) before, in response to, and/or after receiving the initiation data. For example, transaction processing server 1002 may determine to activate the closed end credit account, and in response to determining to activate the closed end credit account, transaction processing server 1002 may communicate a message (e.g., a request message) to user device 1006 that includes a request to initiate activation of the closed end credit account. Transaction processing server 1002 may receive the initiation data from user device 1006 after communicating the message based on the user's response to the request.

In some non-limiting embodiments, transaction processing server 1002 may determine (e.g., automatically) a maximum allotted credit amount (e.g., a maximum total amount of funds) of the closed end credit account (e.g., in the same or similar fashion as determining an allotted credit amount of a closed end credit account as described above). For example, transaction processing server 1002 may determine a maximum allotted credit amount of the closed end credit account based on user data of a user before receiving initiation data. Transaction processing server 1002 may communicate the maximum allotted credit amount to user device 1006 and/or merchant system 1008. Transaction processing server 1002 may receive the initiation data after communicating the maximum allotted credit amount.

As shown in FIG. 4, at step 4004, process 4000 includes generating at least one repayment plan for the closed end credit account. For example, transaction processing server 1002 may generate the at least one repayment plan for the closed end credit account in the same or similar fashion as described above. In some non-limiting embodiments, transaction processing server 1002 may generate the at least one repayment plan for the closed end credit account in response to receiving the credit amount associated with a user selected allotted credit amount of the closed end credit account. In some non-limiting embodiments, transaction processing server 1002 may generate the at least one repayment plan based on user data of the user.

As further shown in FIG. 4, at step 4006, process 4000 includes activating the closed end credit account. For example, transaction processing server 1002 may activate the closed end credit account in the same or similar fashion as described above.

As further shown in FIG. 4, at step 4008, process 4000 includes processing at least one transaction using the closed end credit account. For example, transaction processing server 1002 may process at least one transaction using the closed end credit account in the same or similar fashion as described above.

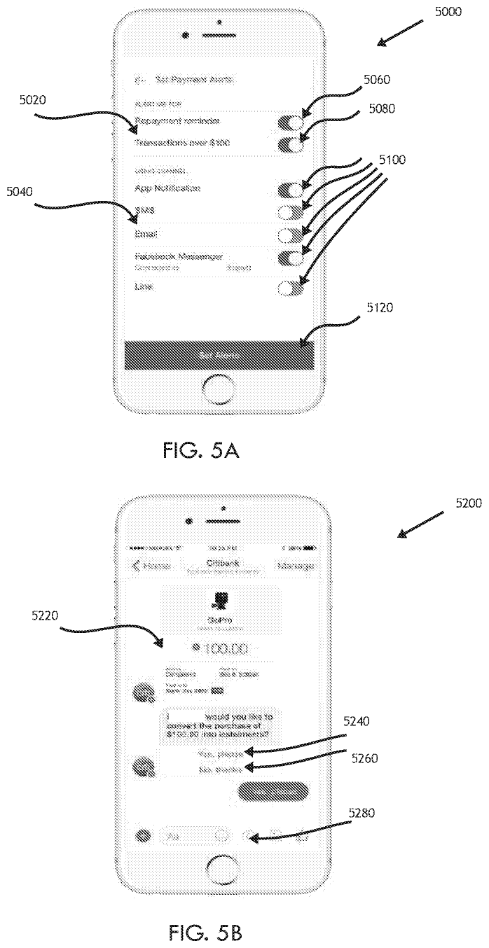

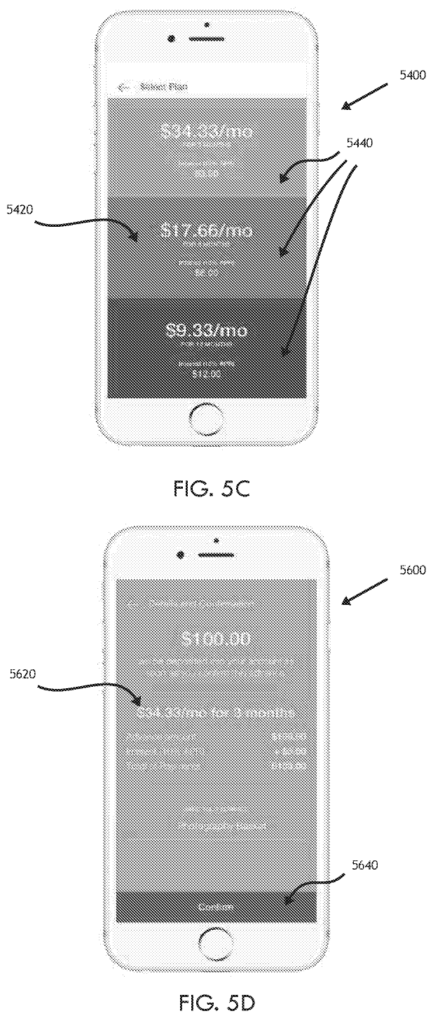

FIGS. 5A-5D show example user interface screens of a user interface displayed by a device (e.g., user device 1006) that may be displayed in relation to process 3000 described above. The user interface screens shown and described with regard to FIGS. 5A-5D may be screens of a user interface that are displayed in association with steps 3002-3010 of process 3000. For example, a device (e.g., transaction processing server 1002) may cause another device (e.g., user device 1006) to display the user interface screens shown in FIGS. 5A-5D as part of steps 3002-3010 of process 3000. In some non-limiting embodiments, the user interface screens shown in FIGS. 5A-5D may be used to display data (e.g., transaction data, user data, merchant data, issuer institution data, and/or the like) received from a device (e.g., transaction processing server 1002, user device 1006), and/or may cause data to be communicated to a device (e.g., transaction processing server 1002, user device 1006, and/or the like) as appropriate with regard to process 3000. In some non-limiting embodiments, the user interface screens shown in FIGS. 5A-5D may be associated with an application that is used to provide a closed end credit account associated with a debit account.

As shown in FIG. 5A, user interface screen 5000 may be a configuration settings screen (e.g., a set payment alerts screen) displayed by user device 1006 and/or merchant system 1008 to receive configuration settings for a user. User interface screen 5000 may include a first section 5020 (e.g., a notification section, an alert section, and/or the like) that includes a plurality of user selectable elements 5060, 5080 and a second section 5040 (e.g., a communication channel section) that includes a plurality of user selectable elements 5100. User interface screen 5000 may also include a user selectable element 5120 that, when activated, saves the configuration settings. In some non-limiting embodiments, transaction processing server 1002 may receive the configuration settings for the user and store the configuration setting in a data storage device (e.g., storage component 2008).

User selectable element 5060 (e.g., a repayment reminder notification element) may be associated with a user's desire to receive notifications (e.g., repayment reminders) associated with a repayment plan for a closed end credit account. For example, when user selectable element 5060 is activated, a notification may be communicated (e.g., a predetermined time period before a payment associated with the repayment plan is due, and/or the like) to user device 1006 associated with the user for which a closed end credit account is provided. User selectable element 5080 (e.g., a predetermined transaction element) may be associated with a user's desire to receive notifications (e.g., transaction notifications) associated with a transaction that meets predetermined transaction criteria based on transaction data of the transaction. For example, when user selectable element 5080 is activated, a notification may be communicated to user device 1006 associated with a user. In some non-limiting embodiments, fewer user selectable elements may be provided than those shown in FIG. 5A. Additionally or alternatively, additional user selectable elements may be provided that are associated with a user's desire to receive notifications associated with other parameters (e.g., whether a closed end credit account has been activated, when a transaction is or is not processed, and/or the like).

User selectable elements 5100 may be associated with a user's desired communication channels to receive notifications (e.g., as described above). For example, when one of user selectable elements 5100 is activated, a notification may be communicated via an application that is used to provide a closed end credit account, a notification may be communicated via a text messaging service (e.g., a Short Message Service (SMS), a Multimedia Messaging Service (MMS)) to the user (e.g., via user device 1006), a notification may be communicated via email to the user (e.g., to an email address associated with the user), a notification may be communicated via a social media account to the user, and/or a notification may be communicated via a voice communication to the user (e.g., via user device 1006).

As shown in FIG. 5B, user interface screen 5200 may be a messaging screen displayed by user device 1006 to display an offer message associated with an offer to activate a closed end credit account. In some non-limiting embodiments, the offer message may be communicated by transaction processing server 1002 (e.g., in response to receiving transaction data of the transaction data, in response to determining that the transaction data corresponds with predetermined transaction criteria, in response to determining to activate a closed end credit account that was involved in the transaction, and/or the like). In some non-limiting embodiments, the text messaging screen may be associated with an application that is used to provide the closed end credit account.

As further shown in FIG. 5B, user interface screen 5200 may include section 5220 (e.g., a message section) where the offer message is displayed. The offer message may include transaction data of a transaction (e.g., a transaction that corresponds with predetermined transaction criteria). For example, the offer message may include product data (e.g., a type of product, “GoPro” as shown, and/or the like), a transaction amount (e.g., “$100” as shown), a type of transaction (e.g., an “online transaction” as shown), issuer institution transaction data (e.g., issuer institution identity data, “Citibank” as shown), timing data (e.g., “Dec 8, 8:30 am” as shown), and user account identity data (e.g., “Citi Bank Visa 2082” as shown). The offer message may also include a text message describing an action to be taken by the user (e.g., “would you like to convert the purchase of $100.00 into installments?” as shown).

As further shown in FIG. 5B, user interface screen 5200 may also include user selectable elements 5240, 5260 for responding to the offer message. For example, when user selectable element 5240 is activated, acceptance data indicating acceptance by the user of the offer to activate a closed end credit account may be communicated via user device 1006. When user selectable element 5260 is activated, decline data indicating that the user is declining the offer to activate a closed end credit account may be communicated via user device 1006. In addition, user interface screen 5200 may also include a section 5280 (e.g., a text input section) that allows a user to provide a text message (e.g., that includes acceptance data, that includes decline data, that includes a request for an additional closed end credit account, and/or the like) in response to the offer message.

As shown in FIG. 5C, user interface screen 5400 may be a repayment plan screen (e.g., a select plan screen) displayed by user device 1006 to display repayment plan parameters of a plurality of repayment plans for a closed end credit account and to receive a user selection associated with one repayment plan of the plurality of repayment plans. In some non-limiting embodiments, the repayment plan parameters for the repayment plans may be communicated to user device 1006 by transaction processing server 1002 (e.g., in response to transaction processing server 1002 generating the repayment plan for the closed end credit account). In some non-limiting embodiments, user interface screen 5400 may be displayed based on user selectable element 5240 being activated.

As further shown in FIG. 5C, user interface screen 5400 may include section 5420 (e.g., a repayment plan display section) that displays user selectable elements 5440 corresponding to each repayment plan of the plurality of repayment plans associated with the closed end credit account. Each of user selected elements 5440 may display repayment plan parameters of each repayment plan for the closed end credit account. For example, the repayment plan parameters may include an interest rate of the repayment plan (e.g., “Interest (10% APR)” as shown in one example), an amount of interest to be paid as part of the repayment plan (e.g., “$3.00” as shown in one example), an overall time interval for repayment of the closed end credit account (e.g., “3 MONTHS” as shown in one example), and a payment amount for each period of the overall time interval for repayment of the closed end credit account (e.g., an amount per month, “$34.33/mo” as shown in one example). In some non-limiting embodiments, by activating one of user selectable elements 5440, acceptance data that indicates acceptance, by the user, of the repayment plan associated with that user selectable element 5440 may be communicated via user device 1006. In some non-limiting embodiments, transaction processing server 1002 may receive the acceptance data in response to the acceptance data being communicated by user device 1006.

As shown in FIG. 5D, user interface screen 5600 may be a confirmation screen (e.g., a details and confirmation screen) displayed by user device 1006 to display the repayment plan parameters of the repayment plan selected by the user and to receive confirmation of the repayment plan selected by the user. User interface screen 5600 may include a section 5620 (e.g., an allotted credit amount display section) that displays the allotted credit amount of the closed end credit account (e.g., “$100.00” as shown), a total amount of funds associated with the repayment plan (e.g., “$103.00” as shown), and the repayment plan parameters of the repayment plan selected by the user (e.g., the same or similar repayment plan parameters as the repayment plan parameters shown in FIG. 5C). Section 5620 of user interface screen 5600 may include additional text (e.g., a text message) associated with the allotted credit amount of the closed end credit account and an identifier associated with the closed end credit account (e.g., a name of the closed end credit account, “Photography Basket” as shown). User interface screen 5600 may also include user selectable element 5640 that, when activated, causes confirmation data (e.g., acceptance data) to be communicated via user device 1006. In some non-limiting embodiments, user interface screen 5600 may be displayed in response to one of user selectable elements 5440 being activated.

In some non-limiting embodiments, by activating user selectable element 5640, acceptance data that indicates acceptance, by the user, of the repayment plan associated with the repayment plan selected by the user (e.g., via user interface screen 5200) may be communicated via user device 1006. In some non-limiting embodiments, transaction processing server 1002 may receive the acceptance data in response to the acceptance data being communicated by user device 1006.

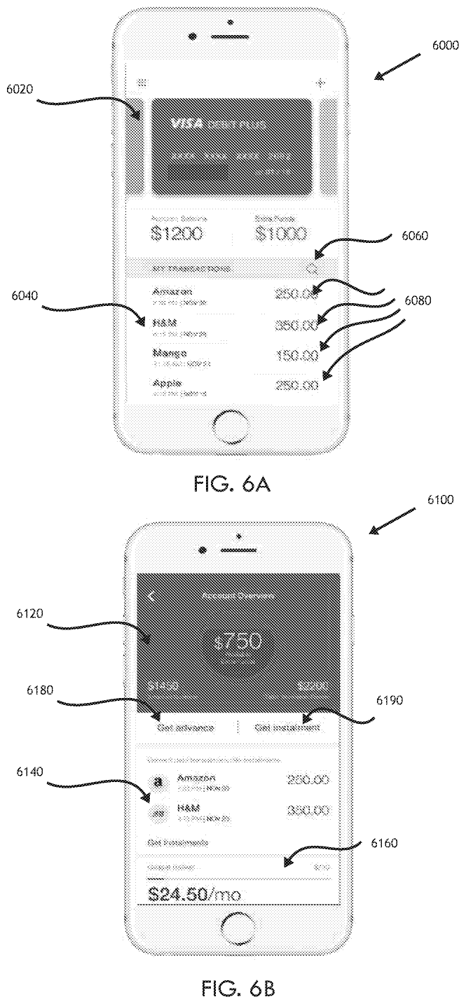

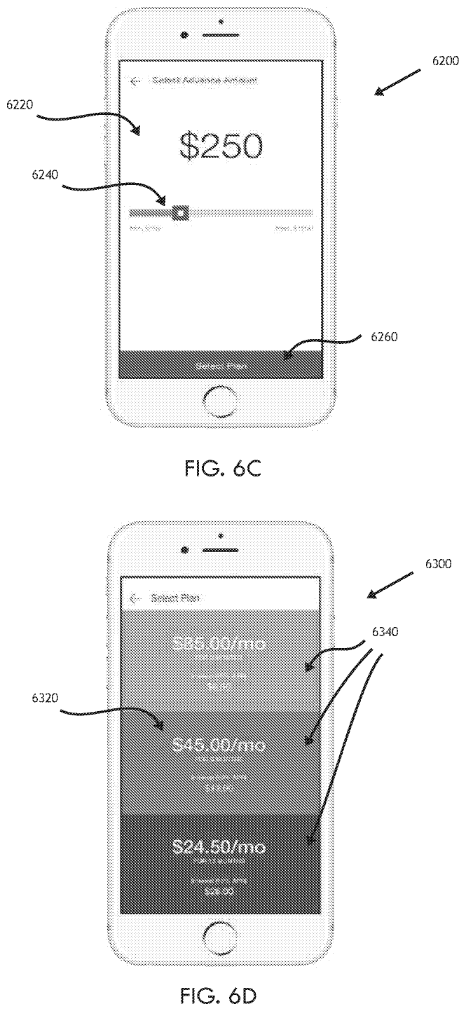

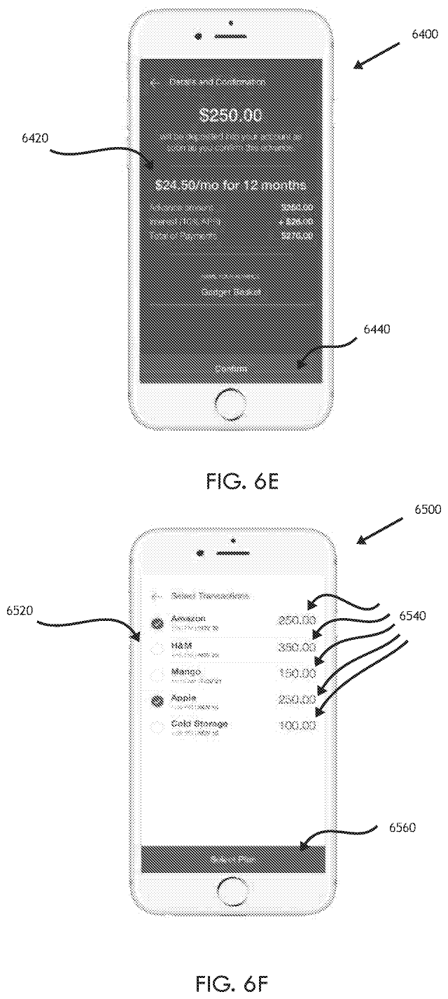

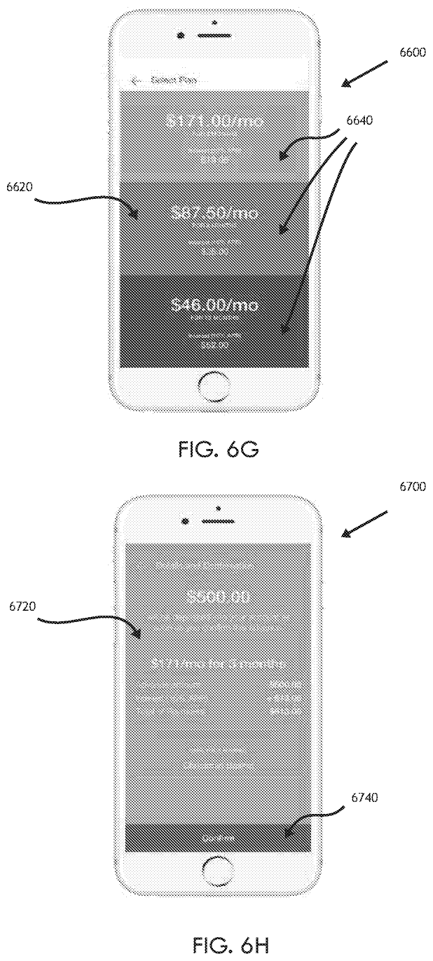

Referring now to FIGS. 6A-6H, FIGS. 6A-6H show example user interface screens of a user interface that may be displayed by a device (e.g., user device 1006) that may be displayed in relation to process 3000 and/or process 4000 described above. The user interface screens shown and described with regard to FIGS. 6A-6H may be screens of a user interface that are displayed in association with steps 3002-3012 of process 3000 and/or steps 4002-4008 of process 4000. For example, a device (e.g., transaction processing server 1002) may cause another device (e.g., user device 1006) to display the user interface screens shown in FIGS. 6A-6H as part of steps 3002-3012 of process 3000 and/or steps 4002-4008 of process 4000. Accordingly, the user interface screens shown in FIGS. 6A-6H may be used to display data (e.g., transaction data, user data, merchant data, issuer institution data, and/or the like) received from a device (e.g., transaction processing server 1002, user device 1006, and/or the like), and/or may cause data to be communicated to a device (e.g., transaction processing server 1002, user device 1006, and/or the like) as appropriate with regard to process 3000 and/or process 4000. In some non-limiting embodiments, the user interface screens shown in FIGS. 6A-6H may be associated with an application that is used to provide a closed end credit account associated with a debit account.

As shown in FIG. 6A, user interface screen 6000 may be a home screen displayed by user device 1006 to receive, from a user associated with user device 1006, a selection of transaction data of at least one transaction that is to be associated with a closed end credit account. User interface screen 6000 may include first section 6020 (e.g., a debit account information section) and second section 6040 that includes user selectable element 6060 and a plurality of user selectable elements 6080. In some non-limiting embodiments, first section 6020 (e.g., a debit account display section) may display a name of the user and/or debit account data (e.g., an account identifier associated with the debit account, a debit account balance of the debit account, “$1200” as shown) associated with a debit account of the user. First section 6020 may also display an allotted credit amount of a closed end credit account (e.g., a closed end credit account that is to be activated, a closed end credit account that is activated, and/or the like). User selectable element 6060, when activated, may provide the user with a search functionality for searching transactions (e.g., past transactions) involving the user. Each of user selectable elements 6080 may correspond to a transaction involving the user and each of user selected elements 6080 may display transaction data of a transaction. For example, the transaction data may include a transaction amount of the transaction (e.g., the transaction amount, “250.00” as shown in one example), merchant identity data of a merchant involved in the transaction (e.g., the name of the merchant, “Amazon” as shown in one example), and timing data of the transaction (e.g., the time of day and day of the month, “7:30 PM|NOV 30” as shown in one example). In some non-limiting embodiments, by activating one of user selectable elements 6080, transaction data of the user selected element that was activated may be communicated to transaction processing server 1002 via user device 1006.

As shown in FIG. 6B, user interface screen 6100 may be an account overview screen displayed by user device 1006 to receive a selection from the user of whether to activate a closed end credit account based on a maximum allotted credit amount available to the user or to activate a closed end credit account based on a transaction amount of at least one transaction. User interface screen 6100 may include first section 6120 (e.g., a debit account information section), second section 6140 (e.g., a closed end credit account initiation section), and third section 6160 (e.g., closed end credit account information section). First section 6120 may display data that is the same or similar to of first section 6020 of user interface screen 6000. For example, first section 6120 may display debit account data (e.g., a debit account balance, “$1450” as shown), an allotted credit amount (e.g., “$750” as shown) of the closed end credit account, and an amount of the debit account added to the allotted credit amount (e.g., “$2200” as shown). Second section 6140 may display transaction data of at least one transaction that was selected via at least one of user selectable elements 6080. Third section 6160 may display closed end credit account data (e.g., repayment plan parameters of a repayment plan of the closed end credit account, an identifier associated with the closed end credit account, a name of the closed end credit account, and/or the like, “Gadget Basket” as shown) and a payment amount for each period of the overall time interval for repayment of the closed end credit account (e.g., an amount per month, “$24.50/mo” as shown). In some non-limiting embodiments, user interface screen 6100 may be displayed in response to one of user selectable elements 6080 being activated.

As further shown in FIG. 6B, first section 6120 may include user selectable elements 6180 and 6190. In some non-limiting embodiments, user selectable element 6180, when activated, may initiate activation of a closed end credit account based on a maximum allotted credit amount available to the user. In some non-limiting embodiments, user selectable element 6190, when activated, may initiate activation of a closed end credit account based on a transaction amount of at least one transaction. In some non-limiting embodiments, activation of user selectable element 6180 and/or user selectable element 6190 may cause user device 1006 to communicate initiation data to initiate activation of a closed end credit account. In some non-limiting embodiments, transaction processing server 1002 may receive the initiation data from user device 1006.

As shown in FIG. 6C, user interface screen 6200 may be an allotted credit amount selection screen (e.g., a select advance amount screen) displayed by user device 1006 to receive a selection from the user of a user selected allotted credit amount for a closed end credit account. User interface screen 6200 may include section 6220 that includes user selectable element 6240 and may display an allotted credit amount (e.g., “$250” as shown) for the closed end credit account in response to user selectable element 6240. In some non-limiting embodiments, user selectable element 6240 may allow the user to select an allotted credit amount between zero and a maximum allotted credit amount for a closed end credit account. User interface screen 6200 may also include user selectable element 6260. In some non-limiting embodiments, user selectable element 6260, when activated, may cause the allotted credit amount that was selected via user selectable element 6240 to be communicated via user device 1006 to transaction processing server 1002. In some non-limiting embodiments, user interface screen 6200 may be displayed in response to user selectable element 6180 being activated.

As shown in FIG. 6D, user interface screen 6300 may be a repayment plan screen (e.g., a select plan screen) displayed by user device 1006 to display repayment plan parameters of a plurality of repayment plans for a closed end credit account and to receive a user selection associated with one repayment plan of the plurality of repayment plans. In some non-limiting embodiments, the repayment plan parameters for the repayment plans may be communicated to user device 1006 by transaction processing server 1002 (e.g., in response to transaction processing server 1002 generating the repayment plan for the closed end credit account). In some non-limiting embodiments, user interface screen 6300 may be displayed based on user selectable element 6260 being activated.

As further shown in FIG. 6D, user interface screen 6300 may include section 6320 that displays user selectable elements 6340 corresponding to each repayment plan of the plurality of repayment plans associated with the closed end credit account. Each of user selected elements 6340 may display repayment plan parameters of each repayment plan that was generated based on the user selected allotted credit amount corresponding to user selectable element 6240 of user interface screen 6200 that was activated. For example, the repayment plan parameters may include an interest rate of the repayment plan (e.g., “Interest (10% APR)” as shown in one example), an amount of interest to be paid as part of the repayment plan (e.g., “$6.50” as shown in one example), an overall time interval for repayment of the closed end credit account (e.g., “3 MONTHS” as shown in one example), and a payment amount for each period of the overall time interval for repayment of the closed end credit account (e.g., an amount per month, “$85.00/mo” as shown in one example). In some non-limiting embodiments, by activating one of user selectable elements 6340, acceptance data that indicates acceptance, by the user, of the repayment plan associated with that user selectable element 6340 may be communicated via user device 1006. In some non-limiting embodiments, transaction processing server 1002 may receive the acceptance data in response to the acceptance data being communicated by user device 1006.

As shown in FIG. 6E, user interface screen 6400 may be a confirmation screen (e.g., a details and confirmation screen) displayed by user device 1006 to display the repayment plan parameters of the repayment plan selected by the user and to receive confirmation of the repayment plan selected by the user. User interface screen 6400 may include a section 6420 that displays the allotted credit amount of the closed end credit account (e.g., “$250.00” as shown), a total amount of funds associated with the repayment plan (e.g., “$276.00” as shown), and the repayment plan parameters of the repayment plan selected by the user (e.g., the same or similar repayment plan parameters as the repayment plan parameters shown in FIG. 6D). Section 6420 of user interface screen 6400 may include additional text (e.g., a text message) associated with the allotted credit amount of the closed end credit account and an identifier associated with the closed end credit account (e.g., a name of the closed end credit account, “Gadget Basket” as shown). User interface screen 6400 may also include user selectable element 6440 that, when activated, causes confirmation data (e.g., acceptance data) to be communicated via user device 1006. In some non-limiting embodiments, user interface screen 6400 may be displayed in response to one of user selectable elements 6440 being activated.

As shown in FIG. 6F, user interface screen 6500 may be a transaction selection screen (e.g., a select transactions screen) displayed by user device 1006 to receive a selection from the user of at least one transaction to be associated with a closed end credit account. User interface screen 6500 may include section 6520 that may include user selectable elements 6540 and user selectable element 6560. Each of user selectable elements 6540 may correspond to a transaction involving the user and each of user selected elements 6540 may display transaction data of a transaction. For example, the transaction data may include a transaction amount of the transaction (e.g., the transaction amount, “250.00” as shown in one example), merchant identity data of the merchant involved in the transaction (e.g., the name of the merchant, “Amazon” as shown in one example), and timing data of the transaction (e.g., the time of day and day of the month, “7:30 PM|NOV 30” as shown in one example). In some non-limiting embodiments, by activating one of user selectable elements 6540, transaction data of the user selected element that was activated may be communicated to transaction processing server 1002 via user device 1006. In some non-limiting embodiments, by activating user selectable element 6560, user device 1006 may communicate transaction data of a transaction corresponding to at least one of user selectable elements 6540 that was activated. In some non-limiting embodiments, transaction processing server 1002 may receive the transaction data in response to user device 1006 communicating the transaction data. In some non-limiting embodiments, user interface screen 6500 may be displayed in response to user selectable element 6190 being activated.

As shown in FIG. 6G, user interface screen 6600 may be a repayment plan screen (e.g., a select plan screen) displayed by user device 1006 to display repayment plan parameters of a plurality of repayment plans for a closed end credit account and to receive a user selection associated with one repayment plan of the plurality of repayment plans. In some non-limiting embodiments, the repayment plan parameters for the repayment plans may be communicated to user device 1006 by transaction processing server 1002 (e.g., in response to transaction processing server 1002 generating the repayment plan for the closed end credit account). In some non-limiting embodiments, user interface screen 6600 may be displayed based on user selectable element 6440 being activated.

As further shown in FIG. 6G, user interface screen 6600 may include section 6620 that displays user selectable elements 6640 corresponding to each repayment plan of the plurality of repayment plans associated with the closed end credit account that was generated based on transaction data of a transaction corresponding to at least one of user selectable elements 6540 of user interface screen 6500 that was activated. Each of user selected elements 6640 may display repayment plan parameters of each repayment plan for the closed end credit account. For example, the repayment plan parameters may include an interest rate of the repayment plan (e.g., “Interest (10% APR)” as shown in one example), an amount of interest to be paid as part of the repayment plan (e.g., “$13.00” as shown in one example), an overall time interval for repayment of the closed end credit account (e.g., “3 MONTHS” as shown in one example), and a payment amount for each period of the overall time interval for repayment of the closed end credit account (e.g., an amount per month, “$171.00/mo” as shown in one example). In some non-limiting embodiments, by activating one of user selectable elements 6640, acceptance data that indicates acceptance, by the user, of the repayment plan associated with that user selectable element 6640 may be communicated via user device 1006. In some non-limiting embodiments, transaction processing server 1002 may receive the acceptance data in response to the acceptance data being communicated by user device 1006.

As shown in FIG. 6H, user interface screen 6700 may be a confirmation screen (e.g., a details and confirmation screen) displayed by user device 1006 to display the repayment plan parameters of the repayment plan selected by the user and to receive confirmation of the repayment plan selected by the user. User interface screen 6700 may include a section 6720 that displays the allotted credit amount of the closed end credit account (e.g., “$500.00” as shown), a total amount of funds associated with the repayment plan (e.g., 1513.00″ as shown), and the repayment plan parameters of the repayment plan selected by the user (e.g., the same or similar repayment plan parameters as the repayment plan parameters shown in FIG. 6G). Section 6720 of user interface screen 6700 may include additional text (e.g., a text message) associated with the allotted credit amount of the closed end credit account and an identifier associated with the closed end credit account (e.g., a name of the closed end credit account, “Christmas Basket” as shown). User interface screen 6700 may also include user selectable element 6740 that, when activated, causes confirmation data (e.g., acceptance data) to be communicated via user device 1006. In some non-limiting embodiments, transaction processing server 1002 may receive the confirmation data from user device 1006. In some non-limiting embodiments, user interface screen 6700 may be displayed in response to one of user selectable elements 6640 being activated.

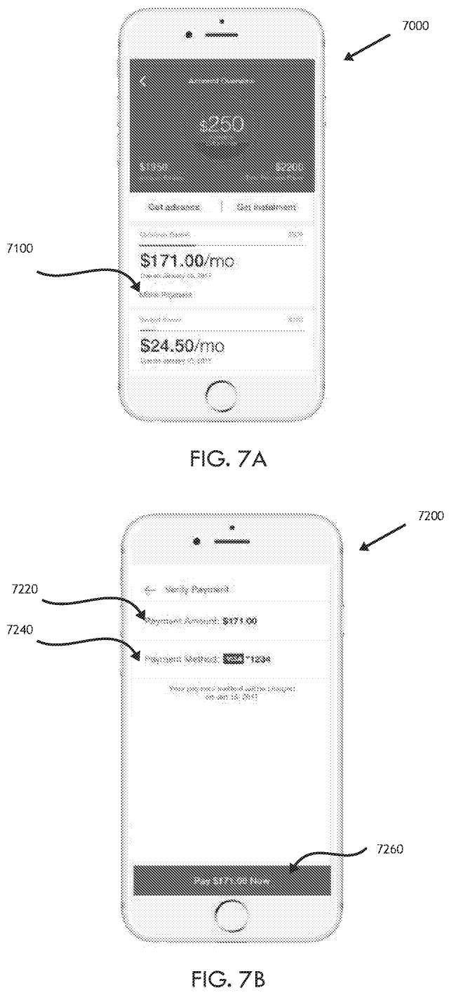

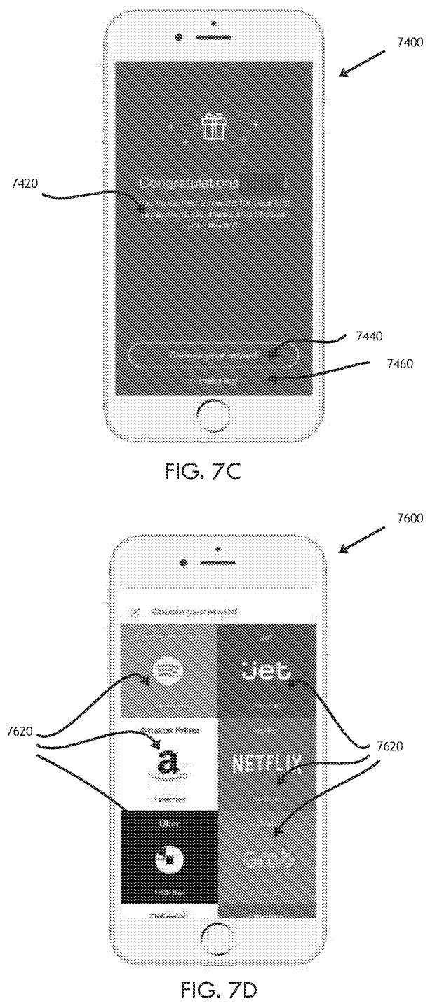

Referring now to FIGS. 7A-7D, FIGS. 7A-7D show example user interface screens of a user interface that may be displayed by a device (e.g., user device 1006) that may be displayed in relation to providing payments and receiving rewards associated with a closed end credit account (e.g., which may include functions that are the same or similar to the steps of process 3000 and/or process 4000 described above). The user interface screens shown and described with regard to FIGS. 7A-7D may be screens of a user interface that are displayed in association with providing payments and receiving rewards associated with the closed end credit account. For example, a device (e.g., transaction processing server 1002) may cause another device (e.g., user device 1006) to display the user interface screens shown in FIGS. 7A-7D as part of providing payments and receiving rewards associated with the closed end credit account. Accordingly, the user interface screens shown in FIGS. 7A-7D may be used to display data (e.g., transaction data, user data, merchant data, issuer institution data, and/or the like) received from a device (e.g., transaction processing server 1002, user device 1006, and/or the like), and/or may cause data to be communicated to a device (e.g., transaction processing server 1002, user device 1006, and/or the like) as appropriate with regard to providing payments and receiving rewards associated with a closed end credit account. In some non-limiting embodiments, the user interface screens shown in FIGS. 7A-7D may be associated with an application that is used to provide payments and receive rewards associated with a closed end credit account.

As shown in FIG. 7A, user interface screen 7000 may be an account overview screen displayed by user device 1006 for an account of a user associated with user device 1006. In some non-limiting embodiments, user interface screen 7000 may the same or similar to user interface screen 6100 shown in FIG. 6B. In addition, user interface screen 7000 may include user selectable element 7100 that, when activated, allows the user to provide a payment for the closed end credit account (e.g., based on the repayment plan for the closed end credit account). For example, by activating user selectable element 7100, another user interface screen may be displayed by user device 1006 that allows the user to select payment data (e.g., a payment amount, an account identifier associated with an account from which a payment may be received, and/or the like) associated with a payment that may be applied to the closed end credit account based on the at least one repayment plan. In some non-limiting embodiments, by activating user selectable element 7100, transaction processing server 1002 may cause a payment (e.g., a transfer of funds from the debit account of the user) to be applied to the closed end credit account based on the at least one repayment plan.

As shown in FIG. 7B, user interface screen 7200 may be a payment screen (e.g., a verify payment screen) displayed by user device 1006 to receive a user selection of an account and payment data associated with an account to apply a payment to the closed end credit account based on the at least one repayment plan. User interface screen 7200 may include user selectable element 7220 and user selectable element 7240. User selectable element 7220 may receive a payment amount associated from a user associated with user device 1006. User selectable element 7240 may receive an account identifier associated with an account of the user from which a payment may be received. User interface screen 7200 may also include user selectable element 7260 that, when activated, may cause a payment to be applied to the closed end credit account based on the payment data received in user selectable element 7220 and user selectable element 7240. In some non-limiting embodiments, by activating user selectable element 7220, user device 1006 may communicate the payment data received in user selectable element 7220 and user selectable element 7240. Transaction processing server 1002 may receive the payment data and cause a payment associated with the payment data to be applied to the closed end credit account. In some non-limiting embodiments, user interface screen 7200 may be displayed in response to user selectable element 7100 being activated.

As shown in FIG. 7C, user interface screen 7400 may be a reward notification screen displayed by user device 1006 that displays a reward notification data based on a reward that may be provided to the user in response to a payment being applied to the closed end credit account. User interface screen 7400 may include a section 7420 that displays the reward notification data (e.g., “You've earned a reward for your first repayment. Go ahead and choose your reward.” as shown) associated with a reward. User interface screen 7400 may also include user selectable element 7440 and user selectable element 7460. User selectable element 7440, when activated, may allow the user to select the reward. For example, when user selectable element 7440 is activated, another user interface screen may be displayed by user device 1006 that allows the user to select the reward that may be provided to the user. User selectable element 7460, when activated, may cause user device 1006 to display a user interface screen that was displayed prior to user interface screen 7400. In some non-limiting embodiments, user interface screen 7400 may be displayed in response to user selectable element 7260 being activated.

As shown in FIG. 7D, user interface screen 7600 may be a reward selection screen (e.g., a choose your reward screen) displayed by user device 1006 to receive a user selection of the reward. User interface screen 7600 may include a plurality of user selectable elements 7620 corresponding to a plurality of rewards (e.g., a loyalty reward offer, a merchant redemption offer, a subscription to an e-commerce company, a subscription to an online streaming service provider, a provision for a ride-sharing service, and/or the like). Each of user selectable elements 7620 may display reward data (e.g., a name of a reward provider, a time period associated with the reward, “Spotify Premium . . . 1 month free” as shown in one example, and/or the like) of the reward corresponding to a user selectable element 7620. In some non-limiting embodiments, by activating one of user selectable elements 7620, user device 1006 may communicate the reward data associated with user selectable element 7620. Transaction processing server 1002 may receive the reward data and cause a message (e.g., a reward message) to be communicated to user device 1006. The message may include data (e.g., a link, a code, a password, and/or the like) associated with accessing the reward. In some non-limiting embodiments, user interface screen 7600 may be displayed in response to user selectable element 7440 being activated.

In some non-limiting embodiments, in each of the user interface screens shown and described with regard to FIGS. 5A-5D, 6A-6H, and 7A-7D, the user interface screens may include at least one user selectable element that, when activated, displays a different user interface screen (e.g., a previous user interface screen, a user interface screen that is ordered after the currently displayed user interface screen, a home user interface screen, and/or the like). In addition, a user selectable element as described herein may include a control element, a link, a hyperlink, a button, a label button, a radio button, a dropdown list, a menu, a toggle, a slider, a bar, a handle, a switch, a check box, a text box, an icon, a cursor, a pointer, an insertion point, and/or the like that is represented on a user interface for the purpose of receiving an input from a user via the user selectable element.

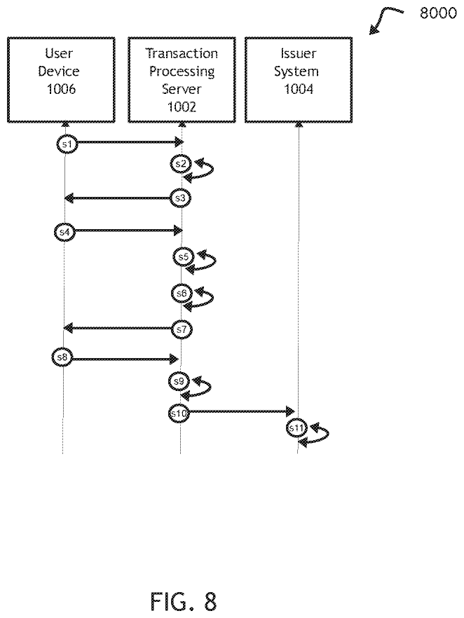

Referring now to FIG. 8, FIG. 8 is a sequence diagram of another non-limiting embodiment of a process 8000 for providing a closed end credit account associated with a debit account. As shown, one or more of the steps of process 8000 are performed (e.g., completely, partially, and/or the like) by transaction processing server 1002, issuer system 1004, and user device 1006. Additionally or alternatively, one or more of the steps of process 8000 may be performed (e.g., completely, partially, and/or the like) by another device or a group of devices separate from or including transaction processing server 1002, issuer system 1004, user device 1006, and/or merchant system 1008.

As shown in FIG. 8, at step s1, user device 1006 may communicate predetermined transaction criteria to transaction processing server 1002 based on an input received from a user associated with user device 1006. At step s2, transaction processing server 1002 may determine that at least one past transaction corresponds with the predetermined transaction criteria based on transaction data of the at least one transaction. The at least one transaction may be between the user and a merchant associated with merchant system 1008 and may involve a debit account of the user. In some non-limiting embodiments, transaction processing server 1002 may receive the transaction data from merchant system 1008. At step s3, in response to determining that the at least one transaction corresponds with the predetermined transaction criteria, transaction processing server 1002 may communicate an offer message to user device 1006. The offer message may include an offer to activate a closed end credit account.

As further shown in FIG. 8, at step s4, transaction processing server 1002 may receive a response message from user device 1006 in response to the offer message. The response message may include acceptance data indicating acceptance of the offer to activate the closed end credit account. At step s5, transaction processing server 1002 may activate the closed end credit account in response to receiving the response message from user device 1006. At step s6, transaction processing server 1002 may generate at least one repayment plan for the closed end credit account. At step s7, transaction processing server 1002 may communicate repayment plan parameters of at least one repayment plan for the closed end credit account to user device 1006. At step s8, user device 1006 may communicate acceptance data to transaction processing server 1002, where the acceptance data indicates acceptance of at least one repayment plan by the user. At step s9, transaction processing server 1002 may activate the closed end credit account. The closed end credit account may have the allotted credit amount. At step s10, transaction processing server 1002 may communicate a message to issuer system 1004. The message may include an instruction for issuer system 1004 to link the closed end credit account to the debit account associated with the user. At step s11, issuer system 1004 may link the closed end credit account to the debit account in response to receiving the message.

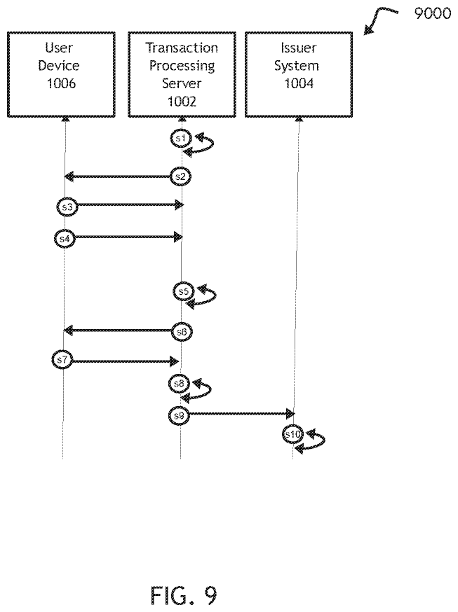

Referring now to FIG. 9, FIG. 9 is a sequence diagram of another non-limiting embodiment of a process 9000 for providing a closed end credit account associated with a debit account. As shown, one or more of the steps of process 9000 are performed (e.g., completely, partially, and/or the like) by transaction processing server 1002, issuer system 1004, and user device 1006. Additionally or alternatively, one or more of the steps of process 9000 may be performed (e.g., completely, partially, and/or the like) by another device or a group of devices separate from or including transaction processing server 1002, issuer system 1004, user device 1006, and/or merchant system 1008.

As shown in FIG. 9, at step s1, transaction processing server 1002 may determine a maximum allotted credit amount for a closed end credit account to be provided to a user associated with user device 1006. At step s2, transaction processing server 1002 may communicate the maximum allotted credit amount to user device 1006. At step s3, user device 1006 may communicate initiation data to transaction processing server 1002 based on an input received from the user associated with user device 1006. The initiation data may indicate the user's desire to initiate activation of the closed end credit account. At step s4, user device 1006 may communicate a user selected allotted credit amount for the closed end credit account to transaction processing server 1002.

As further shown in FIG. 9, at step s5, transaction processing server 1002 may generate at least one repayment plan for the closed end credit account. At step s6, transaction processing server 1002 may communicate repayment plan parameters of at least one repayment plan for the closed end credit account to user device 1006. At step s7, user device 1006 may communicate acceptance data to transaction processing server 1002, where the acceptance data indicates acceptance of at least one repayment plan by the user. At step s8, transaction processing server 1002 may activate the closed end credit account. The closed end credit account may have the allotted credit amount. At step s9, transaction processing server 1002 may communicate a message to issuer system 1004. The message may include an instruction for issuer system 1004 to link the closed end credit account to the debit account associated with the user. At step s10, issuer system 1004 may link the closed end credit account to the debit account in response to receiving the message.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for providing a closed end credit account associated with a debit account of at least one consumer, the method comprising:
determining, with at least one processor, at least one transaction between the at least one consumer and at least one merchant involving the debit account;
determining, with at least one processor, transaction data of the at least one transaction;
determining, with at least one processor, an allotted credit amount of the closed end credit account based at least partially on at least one credit allotment rule and at least one of the following: the transaction data, user data of the at least one consumer, merchant identity data of the at least one merchant, merchant category data of the at least one merchant, issuer institution data of an issuer institution, or any combination thereof;
generating, with at least one processor, at least one repayment plan for the closed end credit account;
activating, with at least one processor, the closed end credit account having the allotted credit amount; and
processing, with at least one processor, the at least one transaction using the closed end credit account in response to activating the closed end credit account.

2. The method of claim 1, wherein the closed end credit account is activated in response to determining the allotted credit amount.

3. The method of claim 1, wherein generating the at least one repayment plan comprises automatically generating the at least one repayment plan based at least partially on at least one repayment plan rule and at least one of the following: the allotted credit amount, the user data, the merchant identity data, the merchant category data, a transaction amount of the at least one transaction, timing data of the at least one transaction, the issuer institution data, or any combination thereof.

4. The method of claim 1, further comprising transferring or causing funds to be transferred from the debit account of the at least one consumer to the closed end credit account based at least partially on the at least one repayment plan.

5. The method of claim 1, further comprising: receiving, from a mobile device associated with the at least one consumer, at least one of the following: the merchant identity data, the merchant category data, the user data, the issuer institution data, or any combination thereof.

6. The method of claim 1, further comprising:
generating at least one message; and
communicating the at least one message to the at least one consumer.

7. The method of claim 6, wherein the at least one message comprises at least one of the following:
an offer to activate the closed end credit account,
transaction data of at least one past transaction that is eligible to be associated with the closed end credit account,
transaction data of at least one past transaction that is eligible to be associated with another closed end credit account,
a plurality of repayment plans each associated with different repayment plan parameters,
an offer to activate an open end credit account, or
any combination thereof.

8. The method of claim 6, wherein communicating the at least one message to the at least one consumer comprises communicating the at least one message to a mobile device associated with the at least one consumer.

9. A system for providing a closed end credit account associated with a debit account of at least one consumer, the system comprising:
at least one processor programmed or configured to:
determine transaction data of at least one transaction between the at least one consumer and at least one merchant;
determine an allotted credit amount of the closed end credit account based at least partially on at least one of the following: the transaction data, user data of the at least one consumer, merchant identity data of the at least one merchant, merchant category data of the at least one merchant, issuer institution data of an issuer institution, or any combination thereof;
activate the closed end credit account having the allotted credit amount;
generate at least one repayment plan for the closed end credit account; and
process the at least one transaction between the at least one consumer and the at least one merchant using the closed end credit account in response to activating the closed end credit account.

10. The system of claim 9, wherein the at least one processor, when determining the allotted credit amount, is further programmed or configured to determine the allotted credit amount before determining the transaction data of the at least one transaction.

11. The system of claim 9, wherein the at least one processor, when generating at least one repayment plan, is further programmed or configured to generate the at least one repayment plan based at least partially on at least one of the following: the merchant identity data, the merchant category data, a transaction amount of the at least one transaction, timing data of the at least one transaction, the user data, the issuer institution data, or any combination thereof.

12. The system of claim 9, wherein the at least one processor is further programmed or configured to cause a user interface to be displayed by a mobile device of the at least one consumer.

13. The system of claim 9, wherein the at least one processor is further programmed or configured to cause a user interface to be displayed, wherein the user interface comprises at least one of the following: debit account data of the debit account, closed end credit account data of the closed end credit account, the allotted credit amount, the merchant identity data, the merchant category data, a transaction amount of the at least one transaction, timing data of the at least one transaction, the user data, the issuer institution data, or any combination thereof.

14. The system of claim 9, wherein the at least one processor is further programmed or configured to cause a user interface to be displayed, wherein the user interface comprises a user selectable element associated with at least one of the following:
an offer to activate the closed end credit account,
transaction data of at least one past transaction that is eligible to be associated with an existing closed end credit account,
transaction data of at least one past transaction that is eligible to be associated with a new closed end credit account,
a plurality of repayment plans each associated with different repayment plan parameters,
an offer to activate an open end credit account, or
any combination thereof.

15. A non-transitory computer-readable medium storing instructions for providing a closed end credit account associated with a debit account, the instructions comprising:
one or more instructions that, when executed by at least one processor, cause the at least one processor to:
receive transaction data of at least one transaction between a user and a merchant that involves a debit account of the user;
determine that the transaction data corresponds with predetermined transaction criteria;
determine an allotted credit amount of the closed end credit account based at least partially on at least one credit allotment rule, the transaction data, and at least one of the following: user data of the user, merchant data of the merchant, issuer institution data of an issuer institution that issued the debit account, or any combination thereof;
generate at least one repayment plan for the closed end credit account;
communicate the at least one repayment plan to a user device associated with the user;
receive acceptance data that indicates acceptance of the at least one repayment plan;
activate the closed end credit account; and
process the at least one transaction in response to activating the closed end credit account.

16. The non-transitory computer-readable medium of claim 15, wherein the transaction data of the at least transaction comprises a transaction amount of the at least one transaction.

17. The non-transitory computer-readable medium of claim 15, where the one or more instructions, when executed by the at least one processor, further cause the at least one processor to determine that the transaction data of at least one transaction corresponds with predetermined transaction criteria.

18. The non-transitory computer-readable medium of claim 17, where the one or more instructions, when executed by the at least one processor, further cause the at least one processor to receive the predetermined transaction criteria from the user.

19. The non-transitory computer-readable medium of claim 15, wherein the user data is first user data, the merchant data is first merchant data, and the issuer institution data is first issuer institution data, and wherein the one or more instructions, that cause the at least one processor to generate the at least one repayment plan, further cause the at least one processor to generate the at least one repayment plan based at least partially on at least one of the following: second user data of the user, second merchant data of the merchant, second issuer institution data of the issuer institution that issued the debit account, or any combination thereof.

20. The non-transitory computer-readable medium of claim 15, wherein the one or more instructions, when executed by the at least one processor, further cause the at least one processor to communicate an offer message to the user device in response to receiving the transaction data of at least one transaction, wherein the offer message comprises on offer to activate the closed end credit account.
